(19) United States
(12) Patent Application Publication
(10) Pub. No.: US 2025/0103987 A1
(43) Pub. Date: Mar. 27, 2025

(54) SYSTEMS AND METHODS FOR DYNAMIC WORKFLOW

(71) Applicant: OPEN TEXT SA ULC, Halifax (CA)

(72) Inventors: Nicholas King, Sidcup (GB); Ravi Shankar Balantrapu Sai Venkat, Hyderabad (IN); Shanti Vardhan Kuravi, Secunderabad (IN)

(21) Appl. No.: 18/474,993

(22) Filed: Sep. 26, 2023

(51) Int. Cl. G06Q 10/0631; G06Q 10/0633

(52) U.S. Cl. CPC G06Q 10/06316; G06Q 10/0633

(57) ABSTRACT

This disclosure provides a dynamic workflow feature that allows an end user to dynamically configure a workflow at runtime. At design time, a dynamic workflow building block is added to an entity in a modeling project in an entity-based application. Adding the dynamic workflow building block adds a task type building block and a task configuration building block. The task type building block is used for defining task type(s), each of which is mapped to a task action using the task configuration building block. Additionally, a dynamic workflow progress panel and layout panels are created. A “Start Workflow” page is configured for creating or modifying a workflow template and for instantiating an instance of the workflow template. A “Workflow Summary” page is configured for summarizing the instance once started and for dynamically adding a task or a step to the instance at runtime of the instance.

### TECHNICAL FIELD

This disclosure relates generally to workflow processing in a networked environment. More particularly, this disclosure relates to dynamic workflow systems, methods, and computer program products that allow users to customize ongoing workflows to suit their needs.

### BACKGROUND OF THE RELATED ART

Today's enterprises and organizations typically have various information systems that hold their business-critical data for their day-to-day operations. In many cases, these operations involve creating and running workflows.

Generally, workflows are developed and predefined by developers for use by non-programmers such as managers and end users. Such workflows, which can be created using a workflow designer tool with workflow templates, tend to be static and automated, such as a loan application, which usually follow a sequential flow of stages or steps.

Existing workflow systems do not allow end users or even managers to modify a workflow while the workflow is ongoing. Rather, a developer is tasked in creating a new workflow or customizing an existing workflow at design time. The developer then restarts the underlying workflow system to activate the new workflow or the customized workflow.

### SUMMARY OF THE DISCLOSURE

A goal of this disclosure is to provide a dynamic workflow solution that enables workflow configuration on the fly. As alluded to above, conventional case management systems and lifecycle-based workflow systems do not provide the ability to quickly and dynamically add a step to an ongoing workflow or add a task to a step of an ongoing workflow. Rather, if changes to a workflow is desired, the changes must be made at design time by a technical person such as a workflow developer or system administrator.

The dynamic workflow solution disclosed herein can be implemented as part of a variety of entity-based applications, not specific to any vertical industry, scale well across different industries, and applicable to different platforms. As a non-limiting example, the dynamic workflow solution disclosed herein is implemented as a feature of a low-code application development platform. The low-code application development platform is useful for building engaging, smart, and easy-to-deploy process automation and dynamic case management applications.

In some embodiments, a method can comprise, at design time, enabling a dynamic workflow feature, the enabling comprising adding a dynamic workflow building block to an entity in a modeling project in an entity-based application, the dynamic workflow building block comprising a task type building block and a task configuration building block. In some embodiments, the method can further comprise, at design time, defining a task type using the task type building block, mapping the task type to a task action using the task configuration building block, creating a dynamic workflow progress panel, and creating layout panels including a first layout panel for starting a workflow and a second layout panel for summarizing the workflow once started. In some embodiments, the creating or modifying a workflow template is performed responsive to user interaction with the first layout panel. In some embodiments, responsive to user interaction with the task configuration building block, a layout for the task type is created or specified. If a layout is not specified, a default layout is used for the task type.

In some embodiments, the method can further comprise, at runtime of the entity-based application, creating or modifying a workflow template responsive to user interaction with the first layout panel, instantiating an instance of the workflow template responsive to user interaction with the first layout panel, and dynamically adding a task or a step to the instance responsive to user interaction with the second layout panel. In some embodiments, the method can further comprise saving an instance of the workflow template thus created or modified as a new workflow template. In some embodiments, the second layout panel can comprise the dynamic workflow progress panel, with the dynamic workflow progress panel showing the instance as the instance progresses from step to step. In some embodiments, responsive to the dynamically adding a task or a step to the instance, a workflow definition file for the instance can be updated and stored in a database.

In some embodiments, both the first layout panel and the second layout panel can comprise a step menu, wherein the step menu of the first layout panel is for adding a step to a workflow or workflow template at design time and wherein the step menu of the second layout panel is for dynamically adding a step to the instance at runtime of the instance. In some embodiments, both the first layout panel and the second layout panel comprise a task menu, wherein the task menu of the first layout panel is for adding a task to a step of a workflow or workflow template at design time and wherein the task menu of the second layout panel is for dynamically adding a task to a step of the instance at runtime of the instance.

In some embodiments, a method can comprise generating a template comprising a plurality of steps, each of the steps comprising at least one task. In some embodiments, the at least one task can comprise a task type, a user assigned to the task, and a task due date. In some embodiments, a template is generated during a design time of the workflow processing. The design time can include configuring a workflow layout for the plurality of steps and tasks of the steps and configuring a workflow progress for the plurality of steps and tasks of the steps.

In some embodiments, the method can further comprise generating a workflow based on the template, initiating an execution of an instance of the workflow, and during the execution of the instance of the workflow at which the instance of the workflow is currently executing at a current step, updating the workflow dynamically.

In some embodiments, dynamically updating the workflow can comprise adding a step to the workflow, adding a task to the added step, and validating the added step and the added task. The validating can comprise determining whether the instance of the workflow is capable of executing the added step and the added task based on the current step and when valid, executing the added step and the added task. In some embodiments, executing the added step and the added task can comprise updating the template based on the added step and the added task.

In some embodiments, initiating the execution of the instance of the workflow can comprise defining the instance of the workflow as a dynamic workflow and configuring the execution of the instance of the workflow to permit adding the step to the workflow and adding the task to the added step.

In some embodiments, determining whether the instance of the workflow is capable of executing the added step and the added task based on the current step can comprise determining whether the added task is insertable between one or more completed steps of the workflow and one or more upcoming steps of the workflow. In some embodiments, the at least one task can comprise a plurality of tasks, each task comprising a task type, the task type from a predefined set of task types, the added task comprising a task type from the predefined set of type tasks. In some embodiments, adding a task to the added step can comprise setting the task type of the added task to one of the task types in the predefined set of task types. In some embodiments, determining whether the added task is insertable can comprise, based on a comparison of the task types of one or more of the plurality of tasks and the added task, determining whether the added task is executable after the current step and at least one task that will be completed before and up to the current step and whether added task is executable before at least one task to be executed after the added task.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatic representation of an example of a low-code application development platform operating in a network environment where embodiments disclosed can be implemented.

FIG. 2 depicts a diagrammatic representation of an example of a user interface through which a user can start a workflow from a workflow template according to some embodiments disclosed herein.

FIG. 3 depicts a diagrammatic representation of an example of a user interface through which a workflow can be modified at design time according to some embodiments disclosed herein.

FIG. 4 depicts a diagrammatic representation of an example of a user interface through which a workflow can be modified at runtime according to some embodiments disclosed herein.

FIG. 5 depicts a diagrammatic representation of an example of a user interface through which a new task can be dynamically added to a workflow at runtime according to some embodiments disclosed herein.

FIG. 6 depicts a diagrammatic representation of an example of a user interface after a new task is dynamically added to a workflow and the workflow is dynamically updated to include the new task according to some embodiments disclosed herein.

FIG. 7 depicts a diagrammatic representation of an example of a user interface showing an entity composed of a plurality of building blocks, including a dynamic workflow building block, according to some embodiments disclosed herein.

FIG. 8 depicts a diagrammatic representation of an example of a user interface showing adding a dynamic workflow building block to an entity adds a task type building block and a task configuration building block to a task list, according to some embodiments disclosed herein.

FIGS. 9A-9C depict diagrammatic representations of an example of a user interface for categorizing tasks by defining the task types using a task type building block, according to some embodiments disclosed herein.

FIG. 10 depicts a diagrammatic representation of an example of a user interface for mapping each task type to a task action using a task configuration building block, according to some embodiments disclosed herein.

FIG. 11 depicts a diagrammatic representation of an example of a user interface showing that, when the dynamic workflow building block is added to a parent entity, a dynamic workflow task is automatically added, according to some embodiments disclosed herein.

FIG. 12 depicts a diagrammatic representation of an example of a user interface showing how to access a layout designer tool from a menu associated with a layout building block, according to some embodiments disclosed herein.

FIG. 13 depicts a diagrammatic representation of an example of a user interface of a layout designer according to some embodiments disclosed herein.

FIGS. 14A-14B show how a new task layout can be created by making a copy of a default layout and modifying a section thereof, according to some embodiments disclosed herein.

FIGS. 15A-15C show how a new task layout can be created by naming the new layout, making sure that the new layout is available for association with a task type, and configuring the layout with a progress bar panel for the dynamic workflow, according to some embodiments disclosed herein.

FIG. 16 depicts a diagrammatic representation of an example of a “Start Workflow” user interface according to some embodiments disclosed herein.

FIG. 17 depicts a diagrammatic representation of an example of a lists view including a list of workflow templates according to some embodiments disclosed herein.

FIGS. 18A-18E show how a new workflow template can be created from scratch according to some embodiments disclosed herein.

FIG. 19 shows an example of the “Start Workflow” user interface being updated with the newly created workflow template for starting a workflow, according to some embodiments disclosed herein.

FIGS. 20-21 show examples of how workflows can be started and then dynamically updated in various ways, according to some embodiments disclosed herein.

FIGS. 22A-22C show by example how a user can modify a step of a running workflow according to some embodiments disclosed herein.

FIG. 23 is a table with an example list of task types and associated user permissions, according to one embodiment disclosed herein.

FIG. 24 is a table with an example list of task fields and associated functionality, according to one embodiment disclosed herein.

FIG. 25 depicts a diagrammatic representation of an example of a workflow summary view of a workflow in progress, according to some embodiments disclosed herein.

FIG. 26 depicts an example of an overall method for enabling a dynamic workflow feature for use in dynamically updating/configuring a workflow at runtime according to some embodiments.

FIG. 27 depicts an example of a method for enabling the dynamic workflow feature according to some embodiments disclosed herein.

FIG. 28 depicts an example of a method that illustrates a dynamic workflow creation process according to some embodiments disclosed herein.

FIG. 29 depicts an example of a method that illustrates a dynamic workflow configuration process according to some embodiments disclosed herein.

FIG. 30 depicts a diagrammatic representation of an example of distributed network computing environment where embodiments disclosed herein can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As alluded to above, workflows tend to be static and automated. Generally, once a workflow starts, it can be terminated, but not altered at runtime. This disclosure provides a dynamic workflow feature that enables any user to create, design, and customize a workflow, including dynamically adding a step and/or a task while the workflow is ongoing.

As a non-limiting example, the dynamic workflow feature can be characterized as a hybrid between case modeling and processing modeling. Case modeling is used in case management and usually involves a series of steps with actions/tasks driven by people. Processing modeling is used in process management and usually involves process lifecycles, each having stages between a beginning and an end of a lifecycle, with the stages linked by relationships that specify dependencies and requirements between them.

With the dynamic workflow feature, one can have a flow of steps with dependencies and different paths to take, as well as adding step(s) and/or task(s) to essentially redesign or otherwise customize a workflow dynamically at runtime, without requiring a developer to change the workflow at design time.

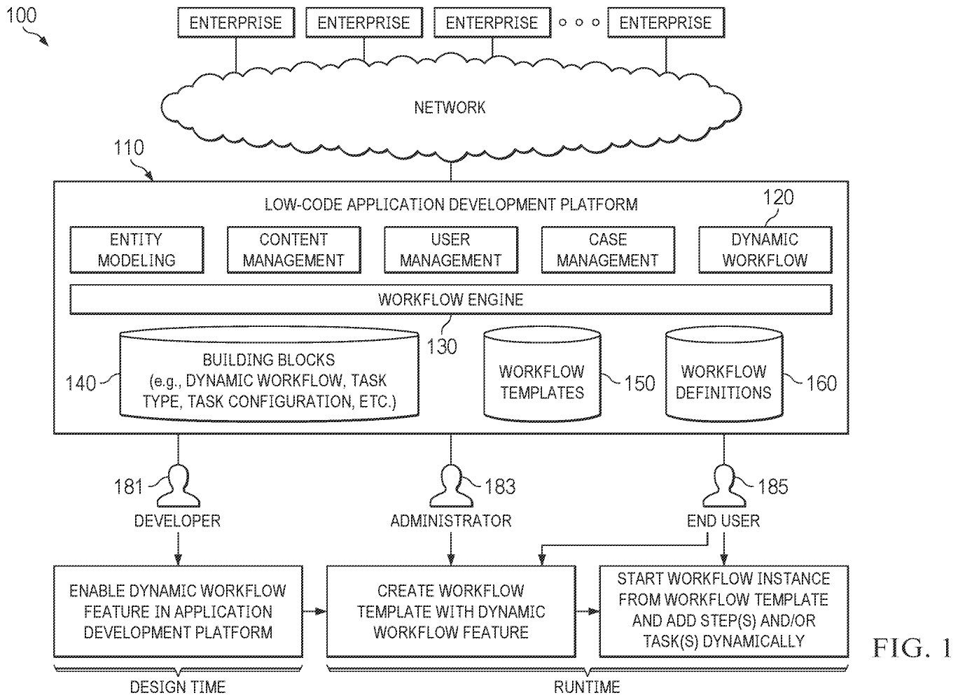

FIG. 1 depicts a diagrammatic representation of an example of a low-code application development platform 110 operating in a network environment 100 where embodiments disclosed can be implemented. In this example, the low-code application development platform comprises the necessary resources, including software and hardware, for developing low-code applications for a variety of enterprise systems such as case management system, content server (e.g., entity modeling system, enterprise content management system, user/directory management system, case management system, etc.).

As those skilled in the art can appreciate, typically, to inject a new task into a workflow, a workflow engine would need to be modified (e.g., by a developer or a programmer) to allow the new task. In some embodiments, the low-code application development platform 110 includes a new dynamic workflow functionality 120 for adding dynamic workflows to these applications so that non-programmer users (e.g., administrators, managers, end users, etc.) can model workflows, initiate or start workflows, and dynamically modify and update workflows at runtime, operated by a workflow engine 130.

The dynamic workflow feature is enabled by a developer 181 at design time. In some embodiments, the dynamic workflow feature is enabled by creating a new dynamic workflow building block, which can be stored with other types of building blocks in a data store 140. In some embodiments, these building blocks can represent a subset of the elements of an entity modeling system operating on an application development platform. An example of a compositional entity modeling system can be found in U.S. Pat. No. 10,019,238, which is incorporated by reference herein. In embodiments disclosed herein, all building blocks are elements, but not all elements are building blocks.

Each building block comprises code instantiated from a class to implement certain settings that can be added to an entity. Such settings may be structural, decorative, and/or functional. In some embodiments, decorative and functional building blocks are treated the same way—as structural building blocks. In some embodiments, these building blocks can be used by entity model builders to assemble or compose entities in a particular project via an entity model designer tool of the entity modeling system. Some entity building blocks can be added to an entity many times, while some entity building blocks can only be added once. Since entity building blocks can be created and managed separately and independently of the entities, there is an open-ended set of possible building blocks that can be added to the entities being modeled. This provides a flexible model for extension (e.g., actions, properties, behaviors, user experience (UX) panels, permissions, REST application programming interfaces (RESTful APIs), etc.).

As will be discussed in detail below, the new dynamic workflow building block can then be used, for example, by an administrator 183 (a user with an administrator role) or an end user 185, in creating or modifying a workflow template at runtime. The workflow template thus created or modified can be published (e.g., to a workflow template store 150) for use by end users. Each workflow template is associated with a workflow definition, which is initially configured at design time and stored in a workflow definition store 160.

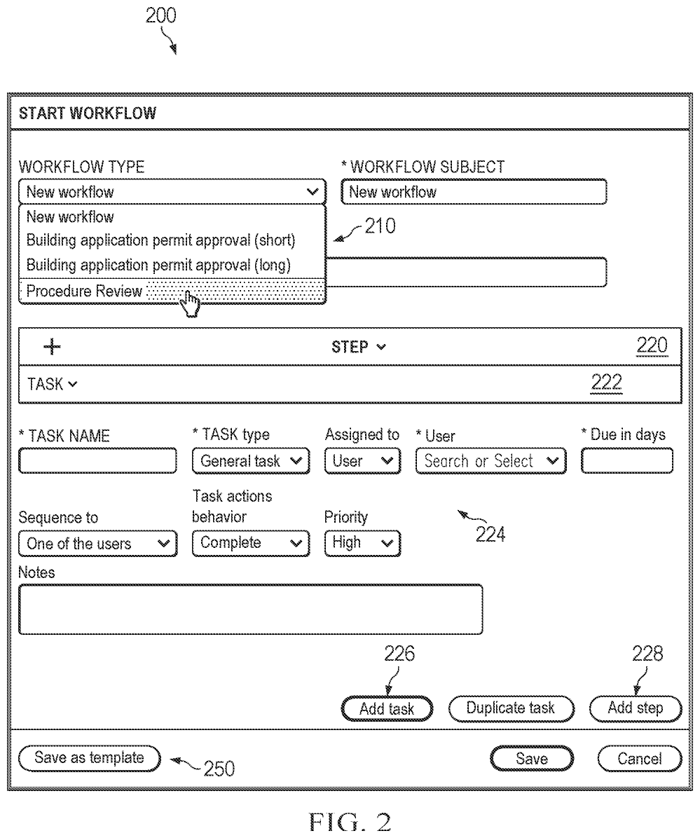

In some embodiments, the dynamic workflow feature provides a user interface to an end user 185 who has permission to start a workflow from a workflow template. An example of this user interface (UI) 200, referred to as “Start Workflow,” is illustrated in FIG. 2.

In some embodiments, the UI 200 includes a pull-down menu 210 that allows the user to start a new workflow from a workflow template (e.g., “Procedure Review”). The UI 200 can be implemented as part of an application developed for an enterprise system using the low-code application development platform such as the one shown in FIG. 1.

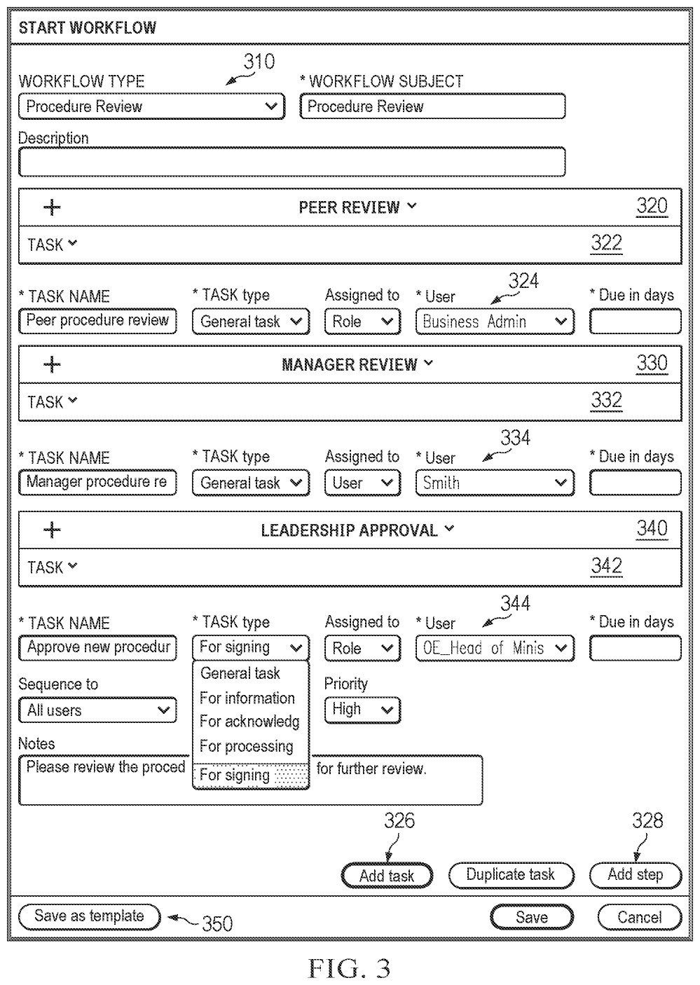

Before starting the workflow (i.e., before instantiating an instance of the workflow template), the user can add step(s) 228 (e.g., via a step menu 220) and/or task(s) 226 (e.g., via a task menu 222 and task input data fields 224) to the workflow. This is illustrated in FIG. 3.

FIG. 3 depicts a diagrammatic representation of an example of a UI 300 through which a workflow can be modified at design time according to some embodiments disclosed herein. In this example, a user has selected, via a menu 310, to start a workflow from the workflow template “Procedure Review” 310. This workflow template has three steps 320, 330, 340, each having respectively associated tasks 324, 334, 344. The user is free to edit any of the steps 320, 330, 340 and/or any of the tasks 324, 334, 344 respectively associated with the steps. Additionally or alternatively, the user can add task(s) 326 and/or step(s) 328 and save the modifications to the workflow in a workflow definition file (which, in one embodiment, can be a JSON file) associated the workflow (i.e., an instance of the workflow template “Procedure Review”). The workflow definition, thus modified for the workflow instance, is updated and stored as a version associated with the workflow instance. The user can also save the workflow thus modified as a new workflow template (by actuating a UI element 350 which causes saving the new workflow template in, for instance, the workflow template store 150 shown in FIG. 1).

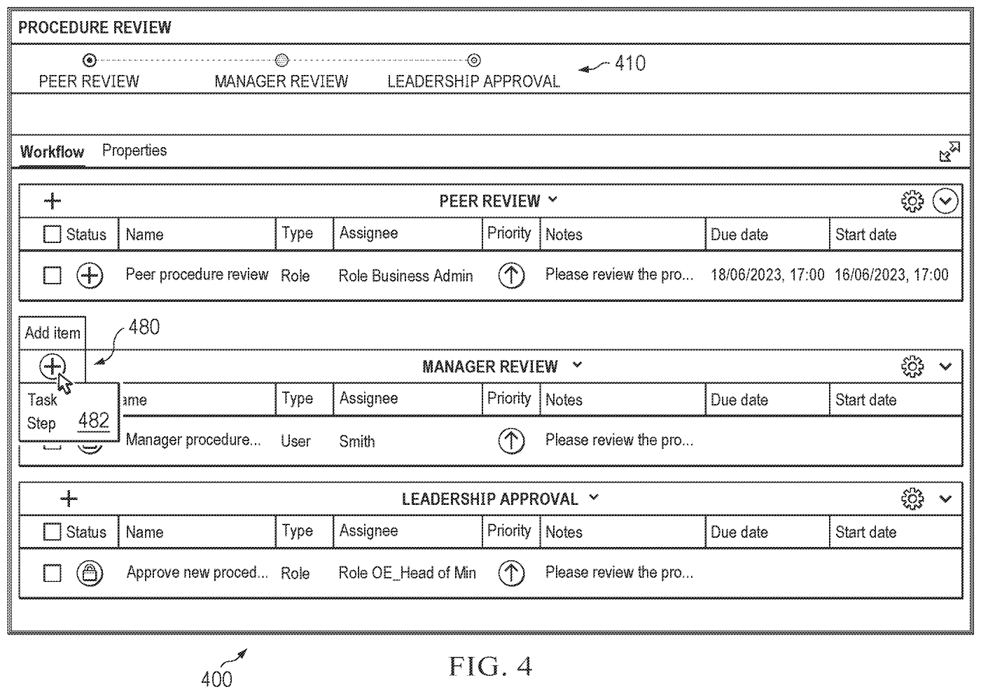

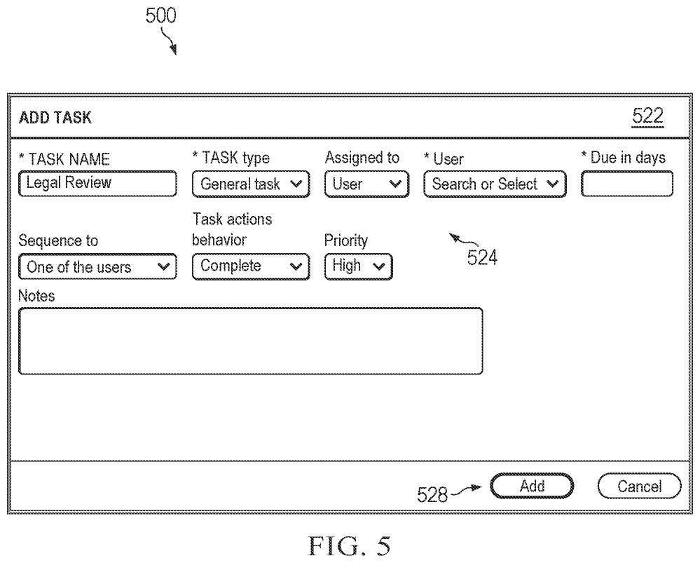

FIG. 4 depicts a diagrammatic representation of an example of a UI 400 through which a workflow can be modified at runtime according to some embodiments disclosed herein. In the example of FIG. 4, a workflow 410 with three steps has started. The first step, “Peer Review,” has been released (i.e., the step has been completed or otherwise worked on). The second and third steps, “Manager Review” and “Leadership Approval,” have not been released (i.e., work in progress, as indicated by a lock icon displayed to indicate the status of an associated step). This could mean that a task is sitting in someone's inbox or the task has not been finished by whomever to which the task is assigned. At this time, an end user with permission to access the workflow 410 can, via a UI element 480, dynamically add a step (e.g., a second “Manager Review,” a “Legal Review,” etc.) anywhere after the first step and/or add a task. The UI element 480, when selected, causes the UI 400 to display a menu 482 through which the user can add a task or a step at runtime. When adding a task is selected, a popup window is displayed, an example of which is shown in FIG. 5.

FIG. 5 depicts a diagrammatic representation of an example of a UI 500 through which a task can be dynamically added to a workflow at runtime according to some embodiments disclosed herein. In this example, the user specifies a new task, “Legal Review” 522 and enters/selects values for parameters such as “Task Name,” “Task Type,” “Assigned to,” “User,” “Due in days,” “Sequence to,” “Task actions behavior,” and “Priority” (entered via task input data fields 524). The user can then select the “Add” button 528 to dynamically add the new task to the workflow while the workflow is ongoing.

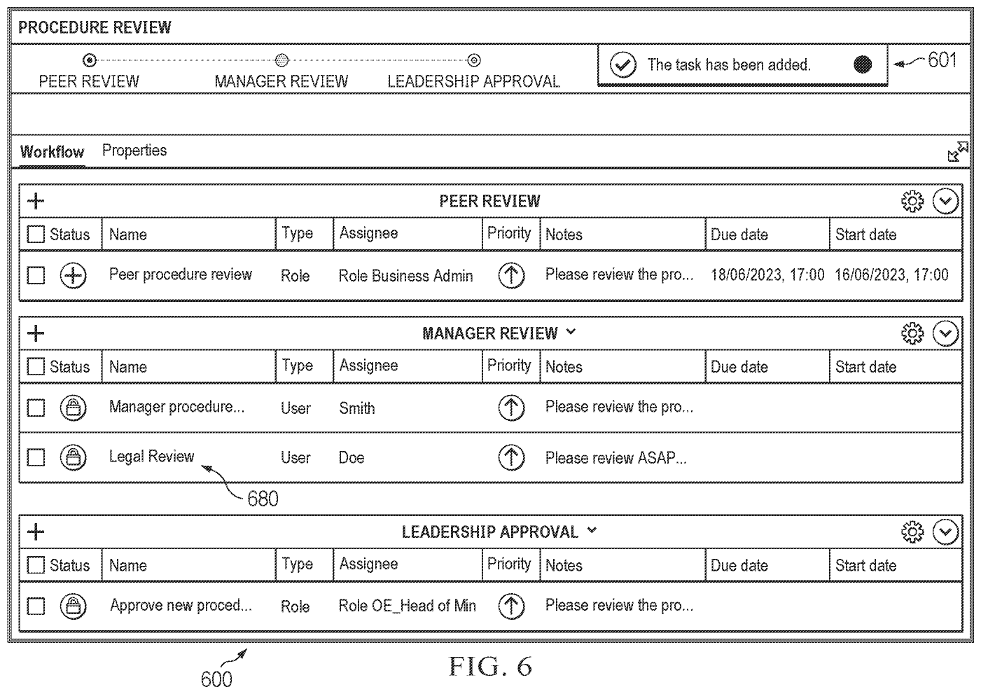

FIG. 6 depicts a diagrammatic representation of an example of a UI 600 after a new task is dynamically added to a workflow and the workflow is dynamically updated to include the new task according to some embodiments disclosed herein. In this example, a notification 601 informs the user that the new task has been added to the workflow and the UI 600 is correspondingly updated to show the new task 680.

In some embodiments, any new tasks added, and/or any changes made, to the workflow at runtime are recorded and tracked via an audit trail supported by the underlying low-code application development environment. The changes do not affect the underlying workflow template from which the workflow is instantiated as an instance.

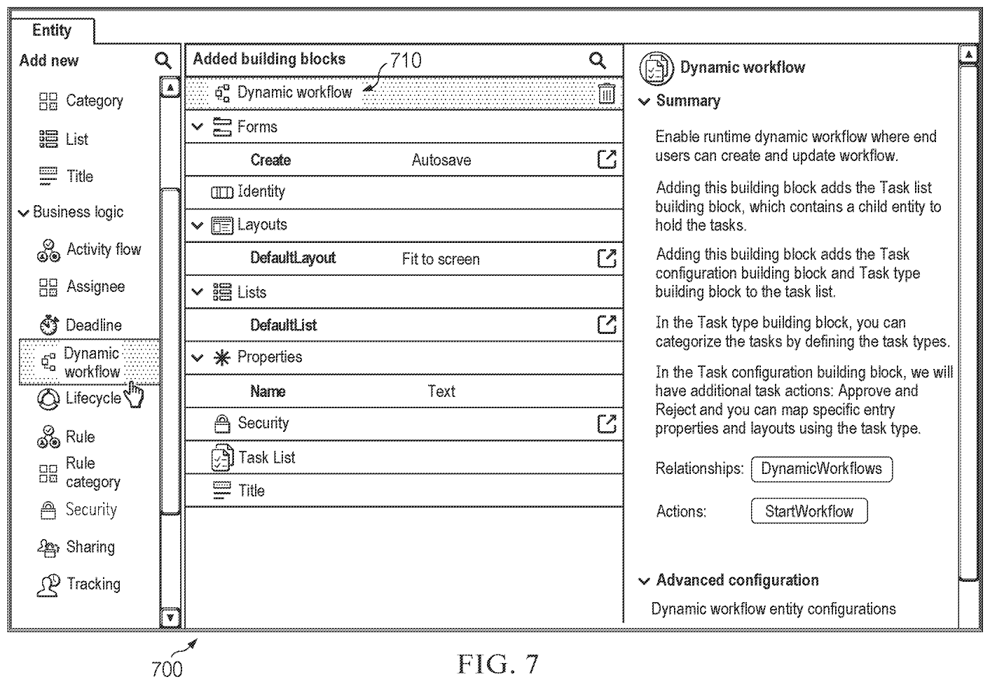

In some embodiments, the dynamic workflow functionality can be packaged (e.g., in an archive file such as a zip file) and deployed to an enterprise computing environment. FIG. 7 depicts a diagrammatic representation of an example of a UI 700 showing an entity composed of a plurality of building blocks, including a dynamic workflow building block 710, in an entity modeling project. In some embodiments, the UI 700 can be provided by an entity model designer tool or a compositional entity modeling system.

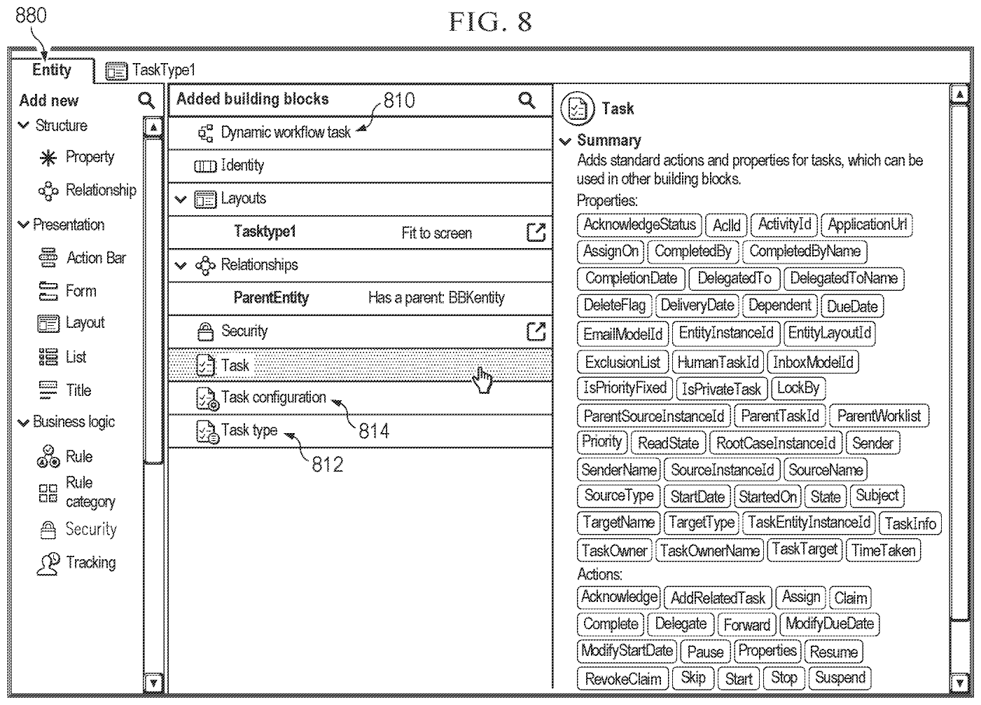

The dynamic workflow package includes the dynamic workflow building block. As illustrated in FIG. 8, adding a dynamic workflow building block 810 to an entity 880 adds a task type building block 812 and a task configuration building block 814 to the task list.

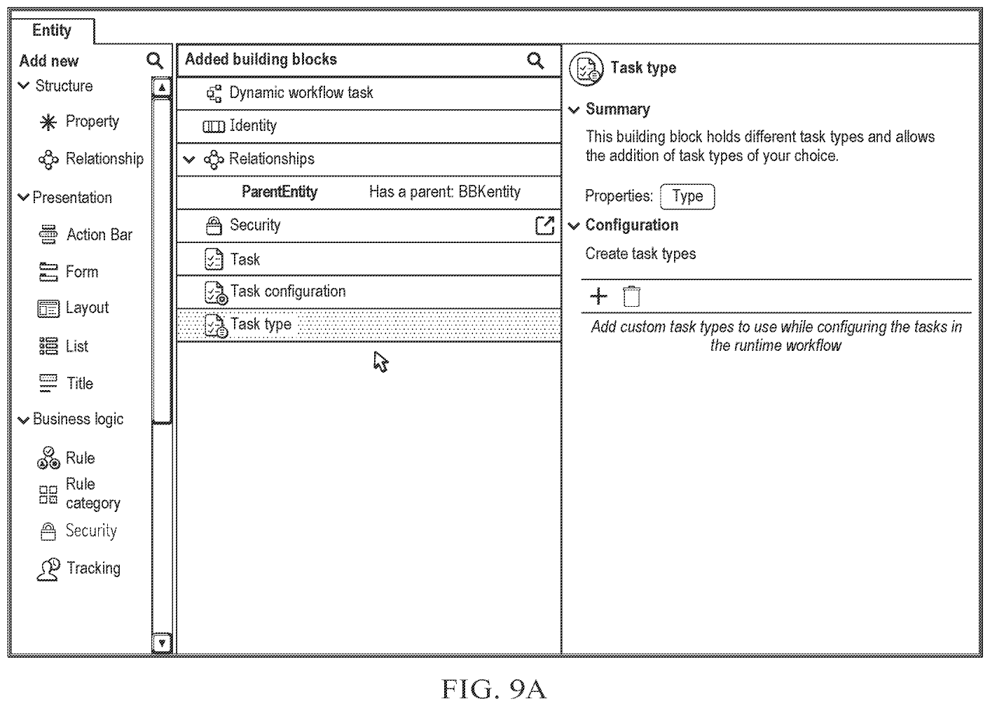

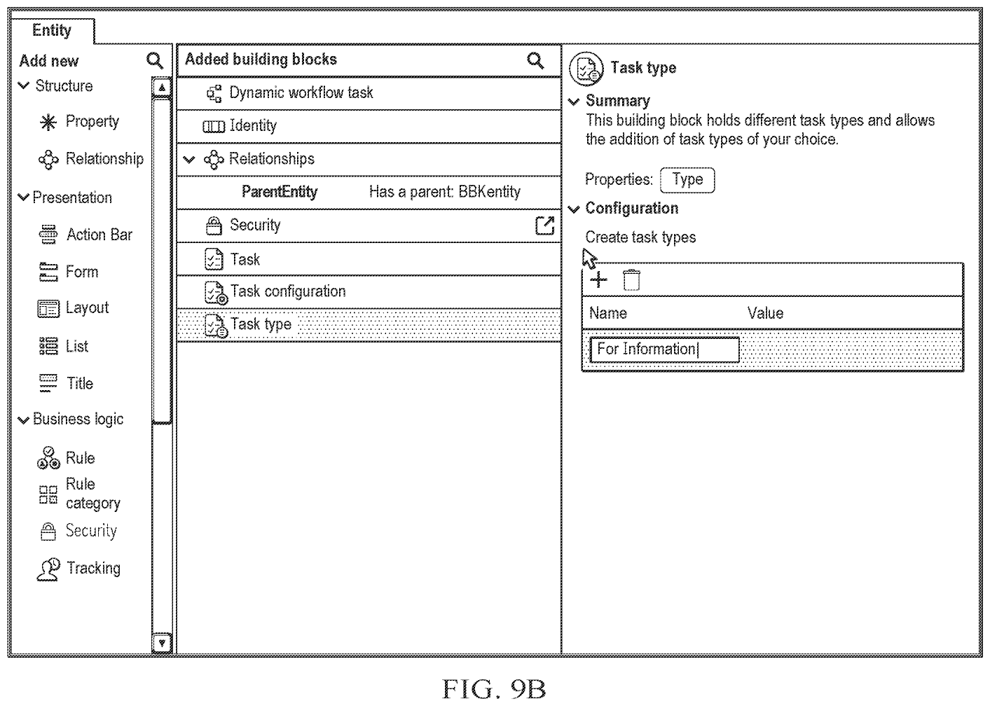

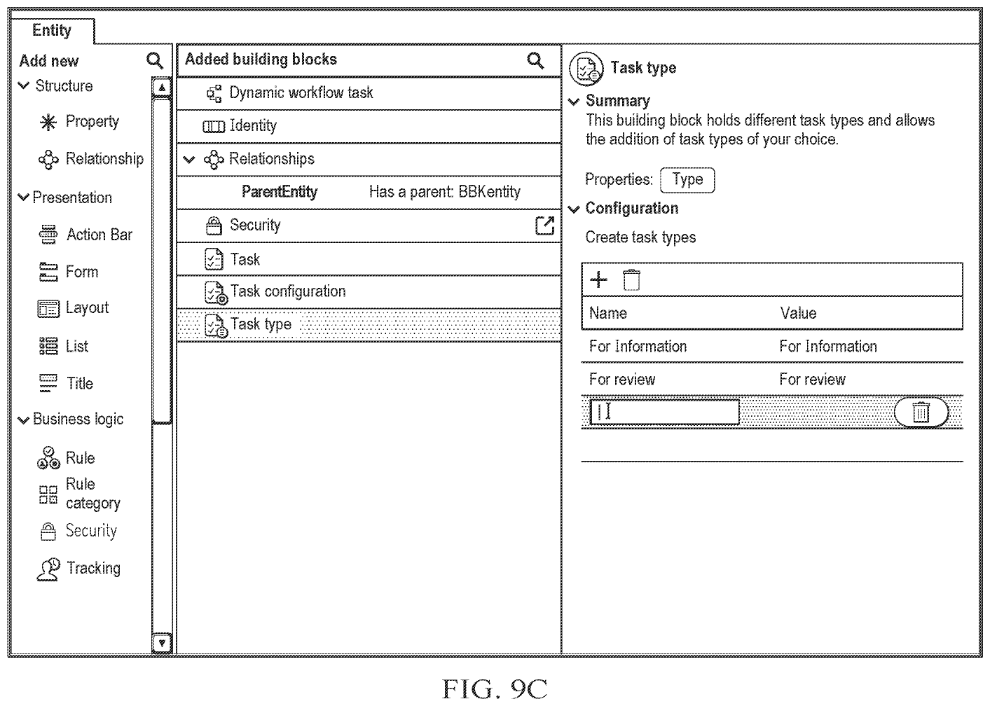

As illustrated in FIGS. 9A-9C, with the task type building block, tasks can be categorized by defining the task types. In some embodiments, the task type building block supports a set of task types: “for processing,” “for information,” “for approval,” and “for review.” Task types can be any name and are not limited to what is shown in FIGS. 9A-9C. The system behavior in the user interface depends on which task action is mapped to the task type. For instance, if a mapped action is approved, then the user will see approve and reject actions. If the mapped action is auto-complete, then the task is auto-completed and only acknowledged action is provided in the user interface. Reject can have multiple flows. In the case of “reject and assign,” the task can be rejected and assigned to the workflow initiator or a specific user. In the case of “Only Reject,” the task is a direct reject. If a workflow is abandoned or if a task is abandoned for any reason, then the workflow or task can be transferred to a different user. If the user has permission on different workflows, then the user can switch between workflows from the workflow summary page without navigating to any other page.

In the example of FIGS. 9A-9C, three task types, “for processing,” “for information,” and “for review,” are created. There can be system-defined task types such as “Relationships.”

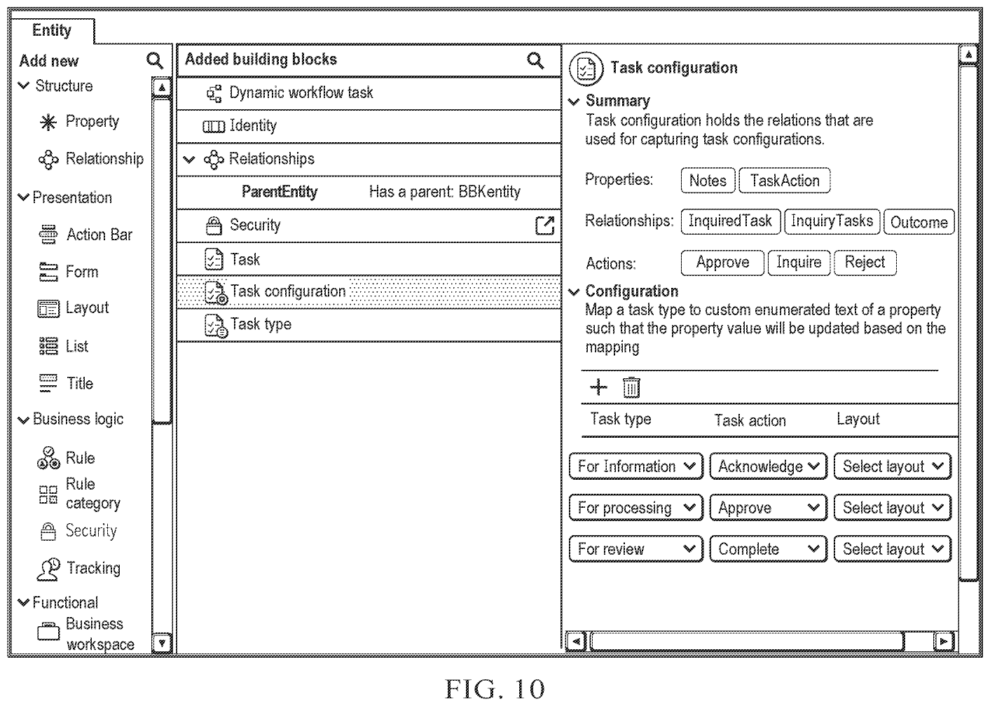

As illustrated in FIG. 10, with the task configuration building block, task actions can be defined and each task type can be mapped to a task action. In some embodiments, the task configuration building block supports a set of task actions: “complete,” “approve,” and “acknowledge.” In some embodiments, each task type is also mapped to a layout. If no layout is selected, a default layout is used.

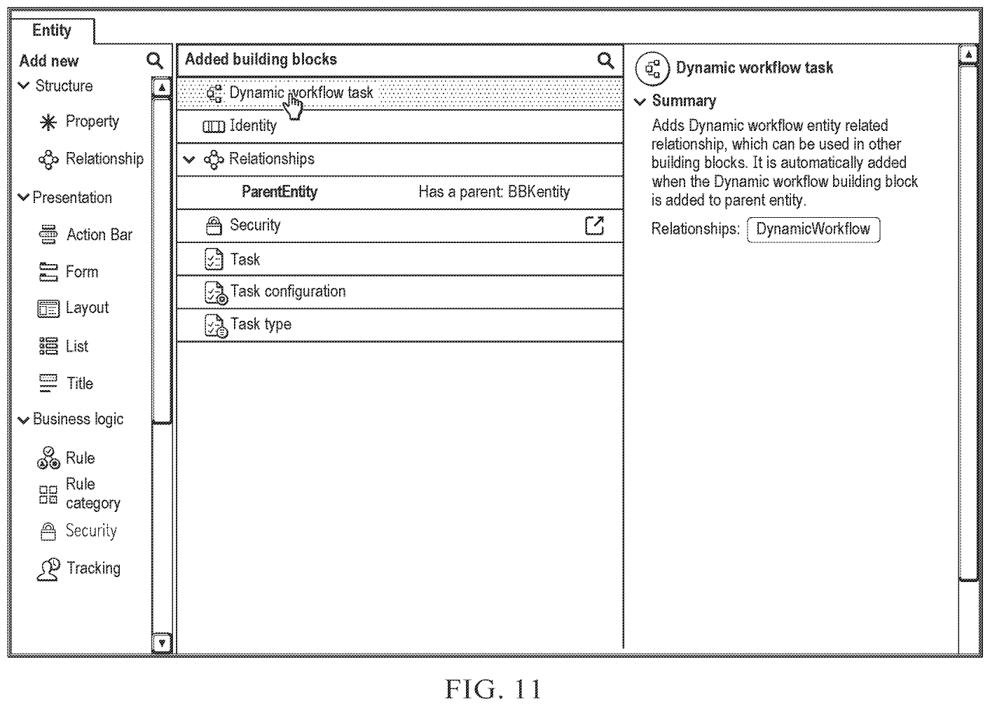

FIG. 11 depicts a diagrammatic representation of an example of a user interface showing that, when the dynamic workflow building block is added to a parent entity, a dynamic workflow task is automatically added. The dynamic workflow task adds a dynamic workflow entity relationship, which can then be used in other building blocks.

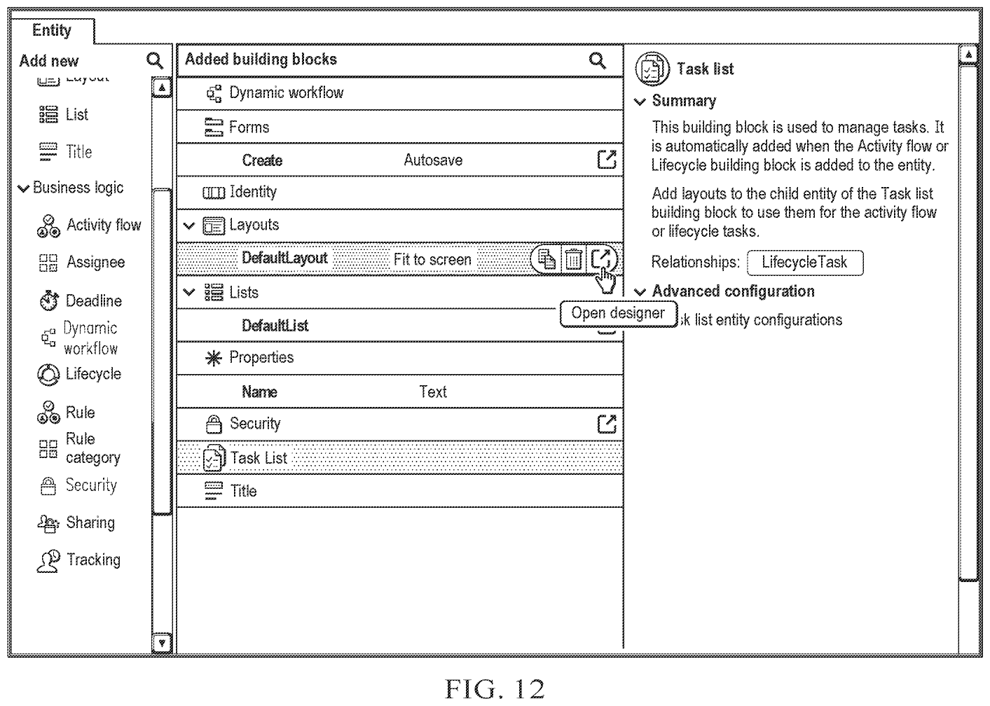

In some embodiments, configuration of a task type includes specifying a layout. A default layout can be used. Alternatively, a new layout can be created using a layout designer tool which, as illustrated in FIG. 12, can be accessed from a menu associated with a layout building block.

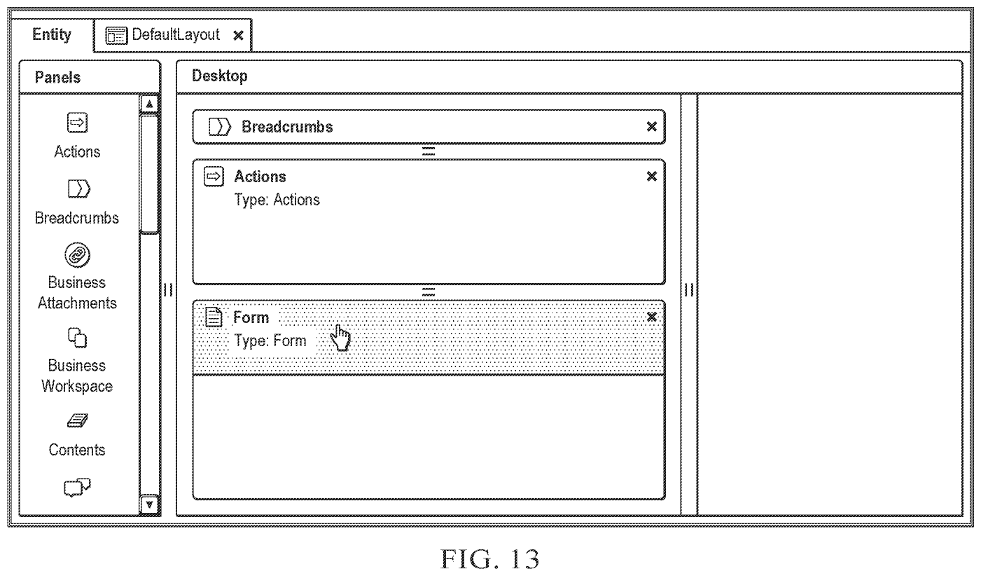

FIG. 13 depicts a diagrammatic representation of an example of a user interface of a layout designer according to some embodiments disclosed herein. In this example, a default layout has a plurality of sections: “Breadcrumbs,” “Actions,” and “forms.”

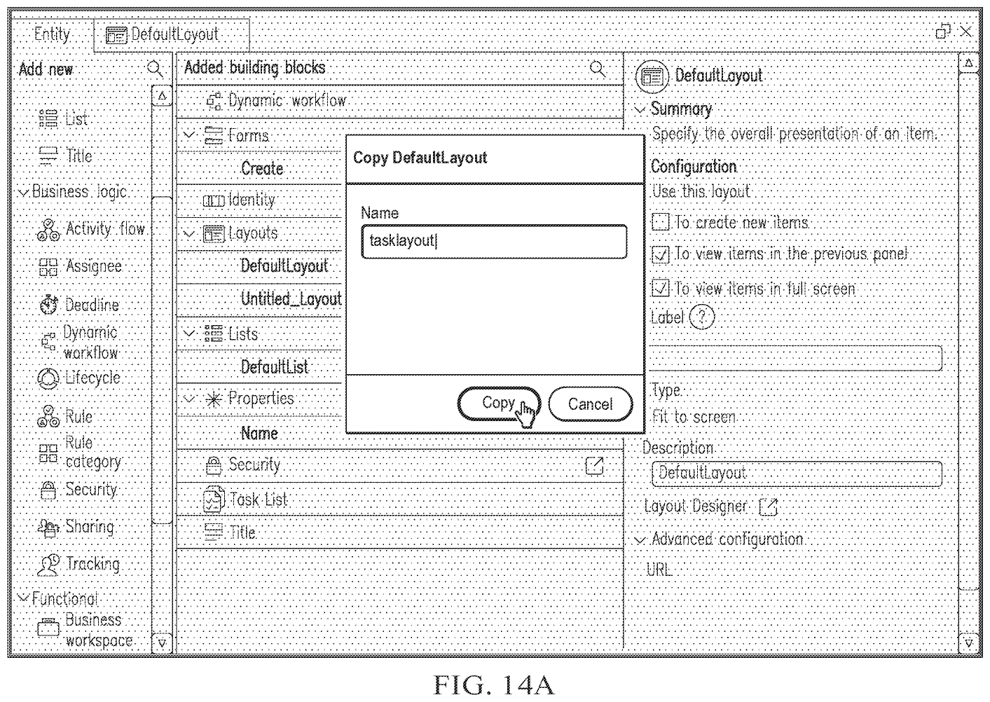

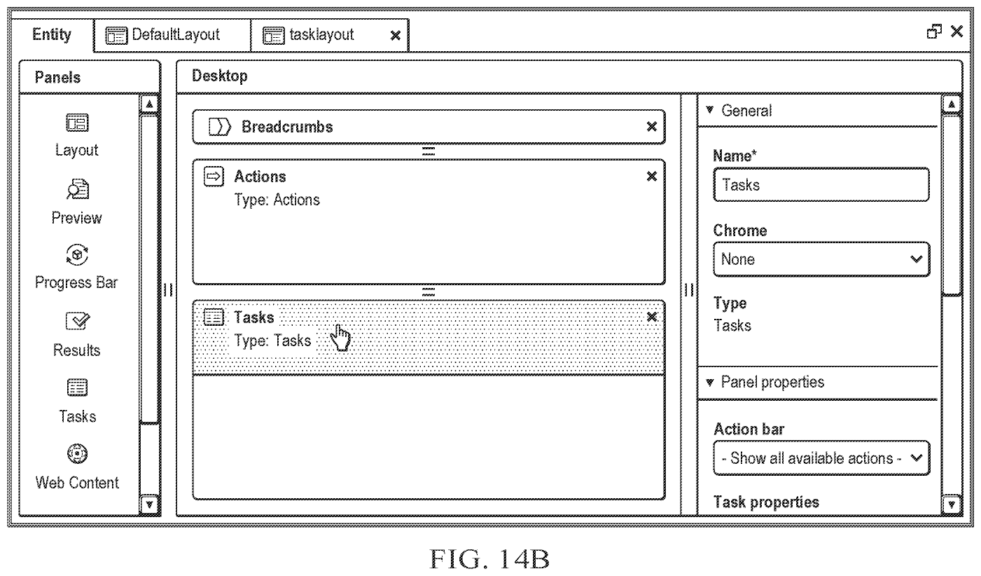

FIGS. 14A-14C show how a new task layout can be created by making a copy of the default layout (FIG. 14A) and modifying a section (e.g., changing one of sections to “Tasks”) (FIG. 14B), according to some embodiments disclosed herein.

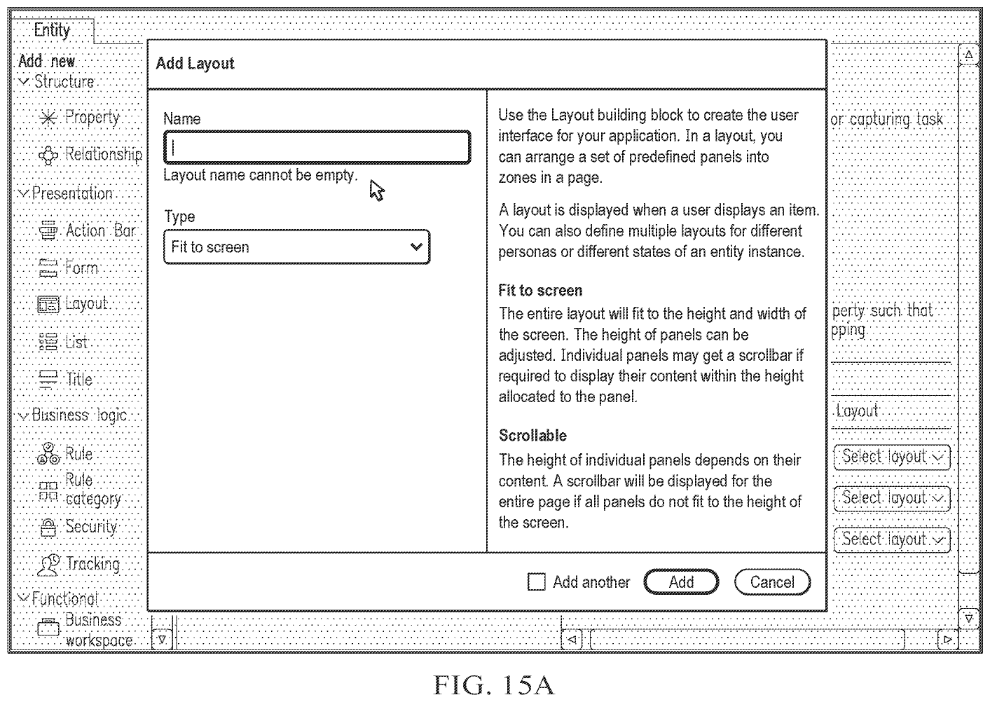

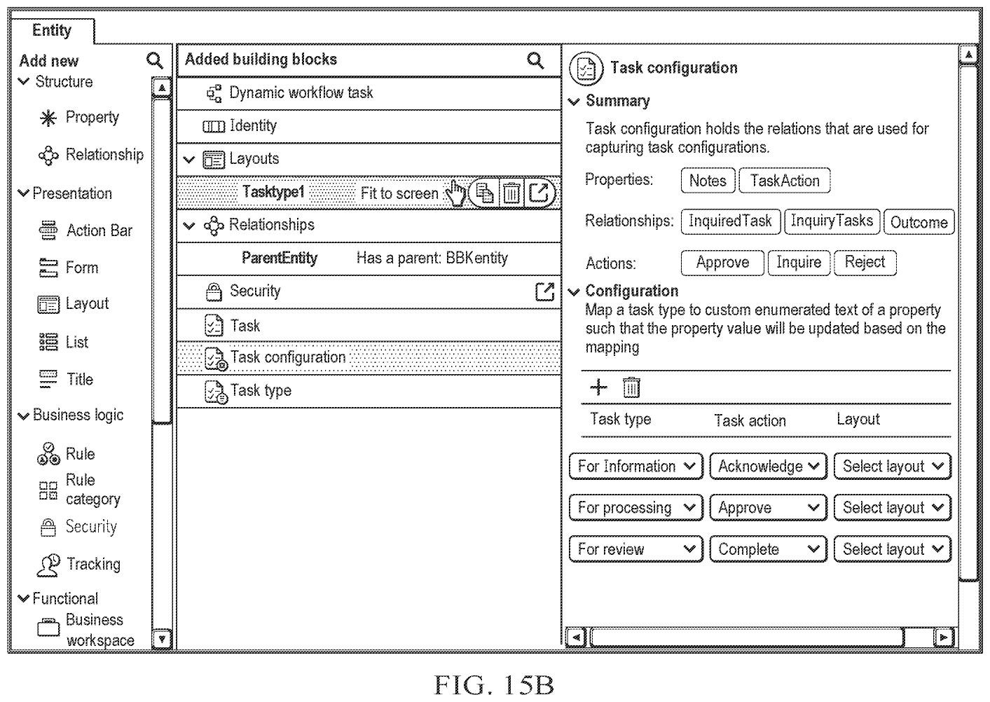

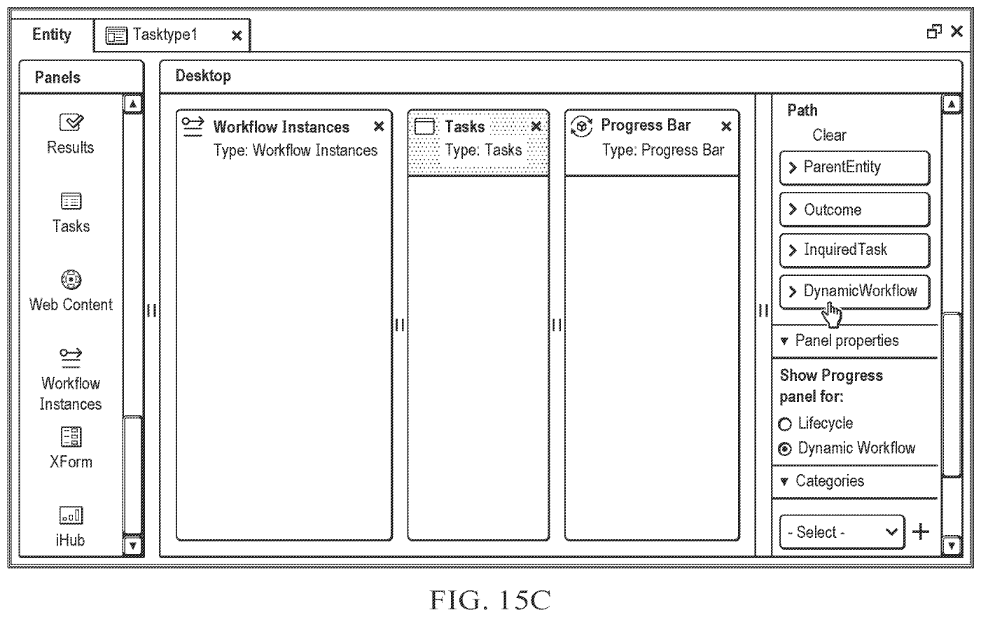

FIGS. 15A-15C show how a new task layout can be created by naming the new layout (FIG. 15A), making sure the new layout is available for association with a task type (FIG. 15B), and configuring the layout with a progress bar panel for the dynamic workflow (FIG. 15C), according to some embodiments disclosed herein. Once the layout is saved, the task configuration building block will include the layout as a selectable item for configuring the task type(s).

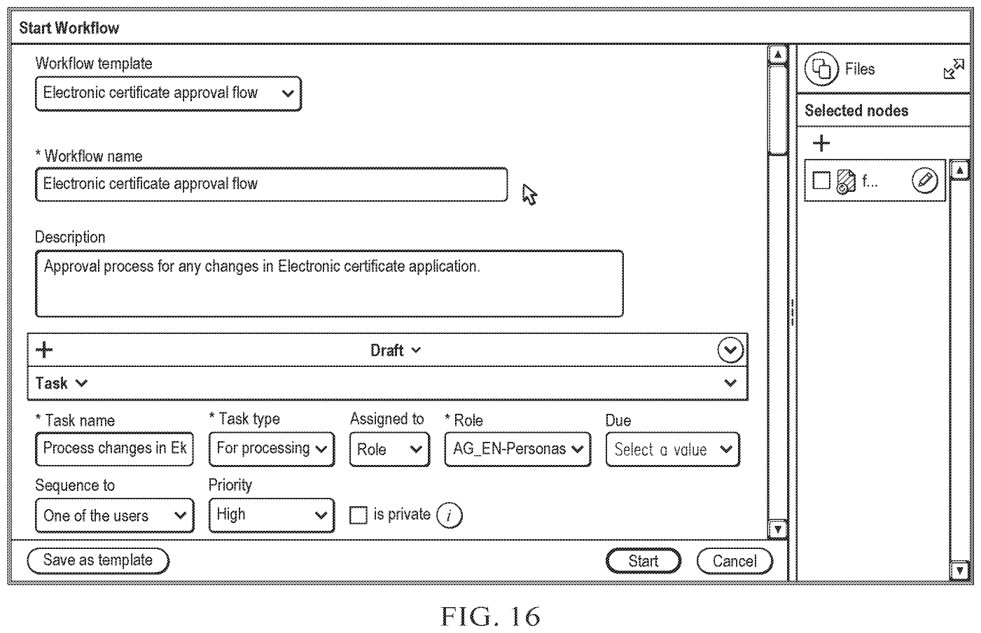

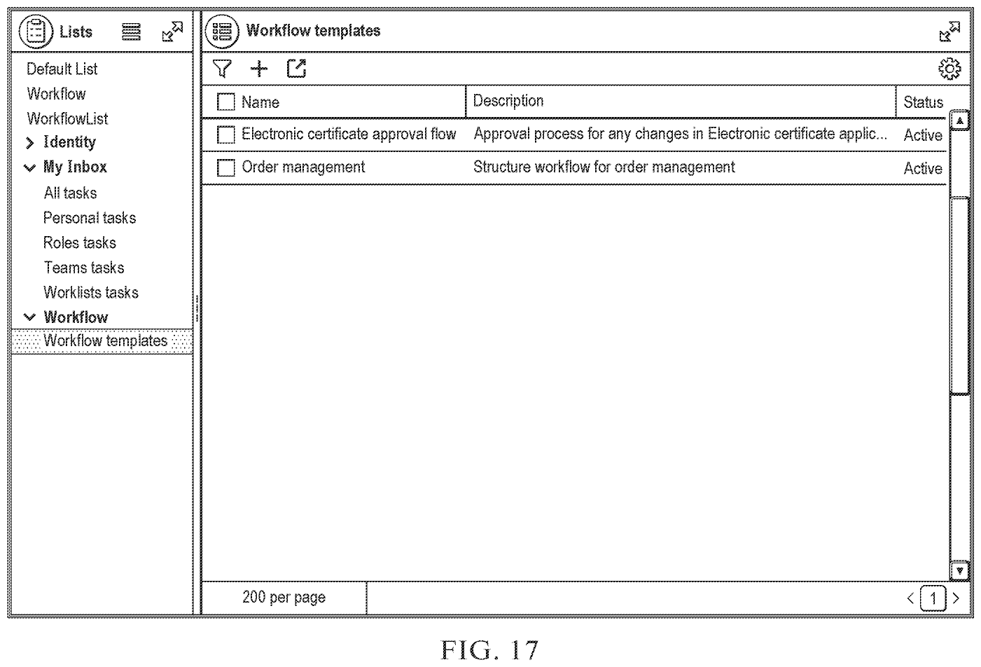

FIG. 16 depicts a diagrammatic representation of an example of a “Start Workflow” UI according to some embodiments disclosed herein. In this example, a workflow template, “Electronic certificate approval flow,” is available to start a workflow or be modified and saved as a new workflow template. An application with a workflow facility enabled with the dynamic workflow feature may provide a list of workflow templates, as illustrated in FIG. 17. A user can create a new workflow template through the “Start Workflow” UI (FIG. 16) or from a window listing existing workflow templates (FIG. 17).

In some embodiments, the workflow template list is visible to users having an entity runtime role. These users are permitted to create/delete/update workflow templates.

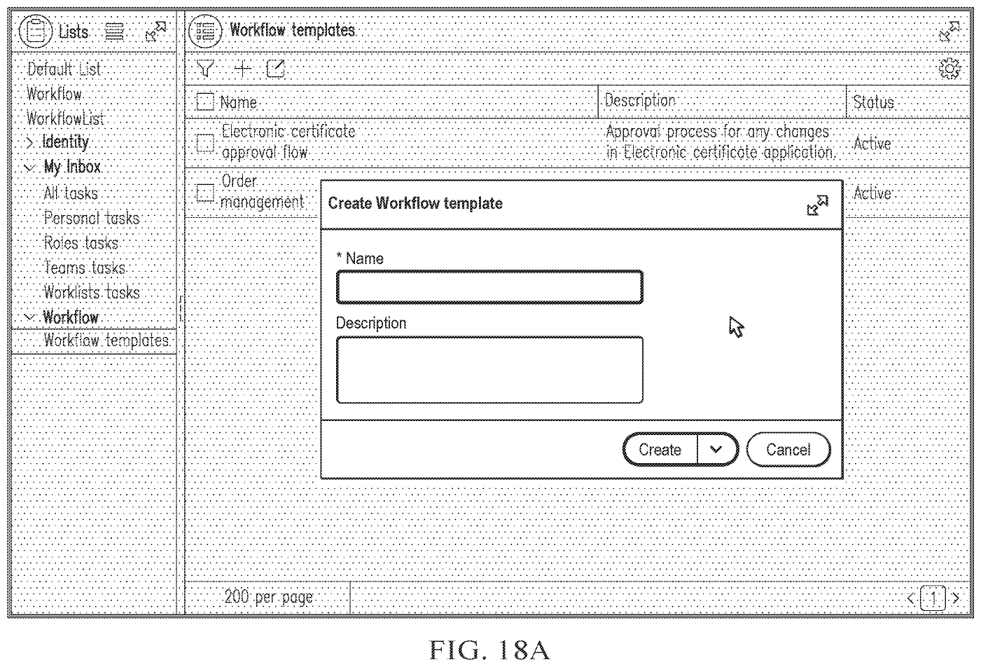

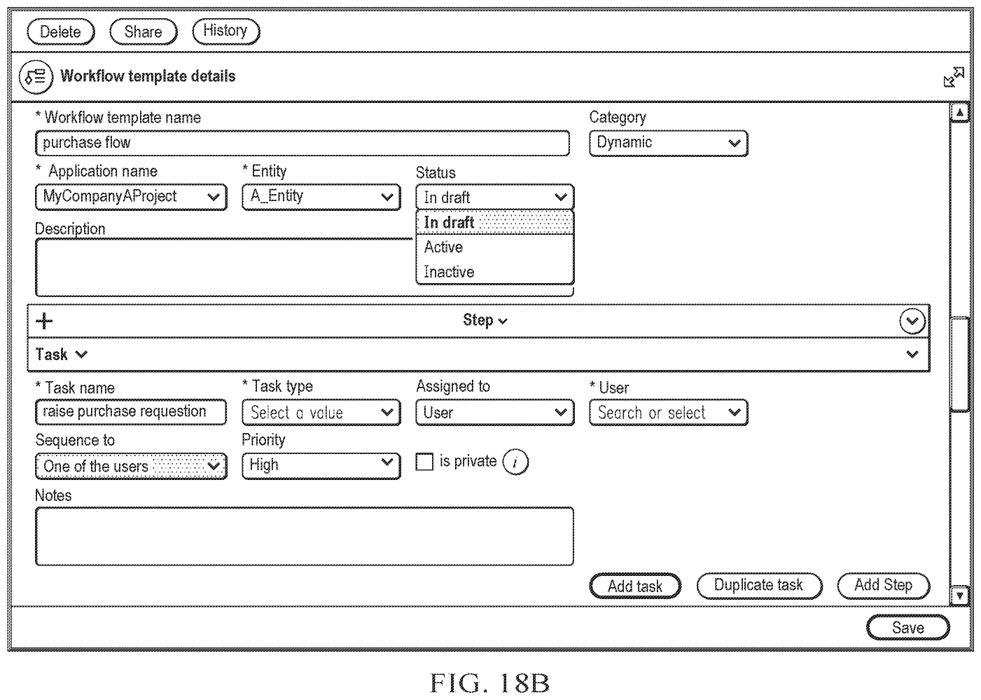

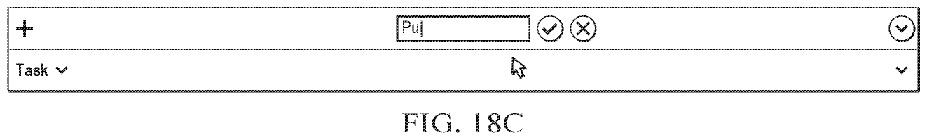

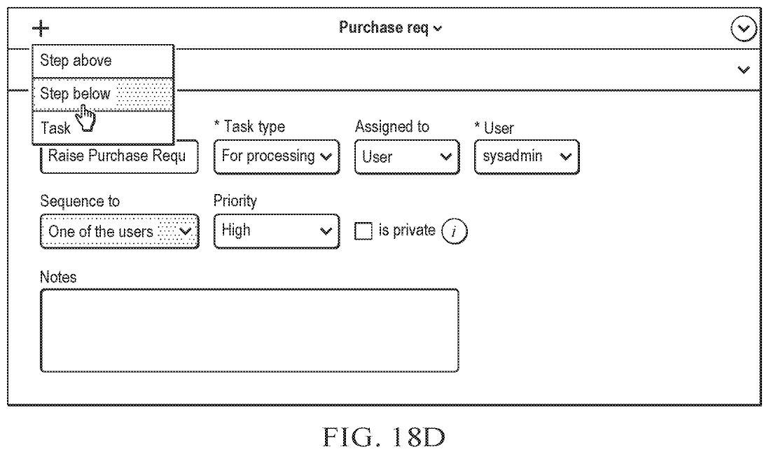

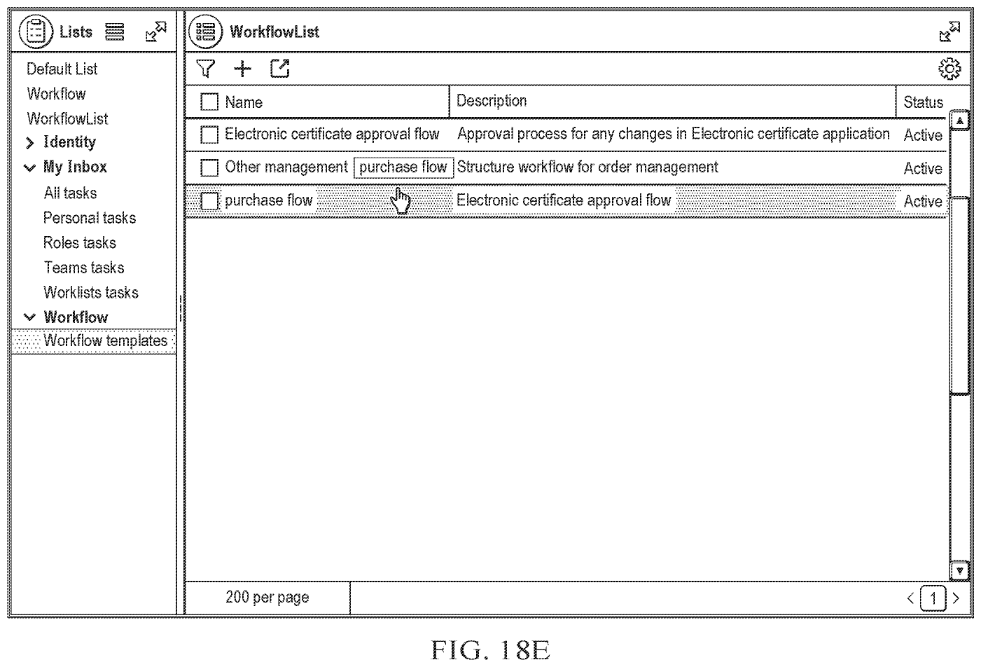

FIGS. 18A-18E show how a new workflow template can be created from scratch according to some embodiments disclosed herein. When a user navigates (e.g., in an entity-based application) to create a new workflow template, a popup window is displayed for the user to specify a name for the new workflow template (FIG. 18A). A page “workflow template details” is then displayed with additional input fields (FIG. 18B) such as application name, entity (from a list of entities defined in the entity-based application), status (e.g., in an inactive step, in an active step, or in a draft step), category, description, etc. for the user to provide details about the new workflow template. By default, the status of this new workflow template is draft. Only active workflow templates will be shown on the “Start Workflow” UI.

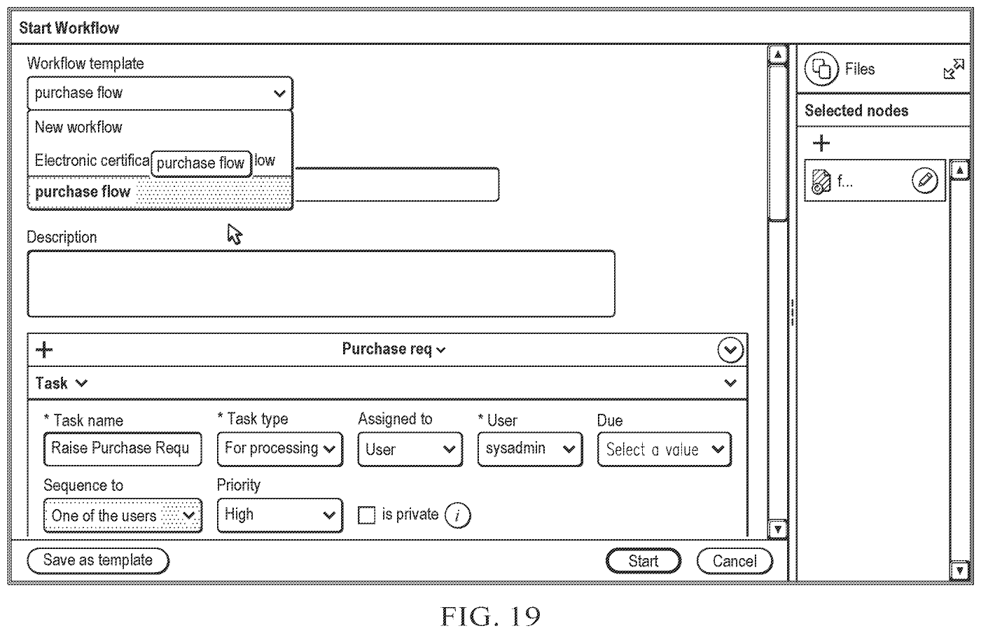

The user can use the step menu and the task menu (similar to the step menu 220 and the task menu 222 described above with reference to FIG. 2) to specify step(s) and/or task(s) for the new workflow template. In the example of FIG. 18C, the user specifies a step “Purchase req” for the workflow template. FIG. 18D shows that the user then adds a step below the step “Purchase req.” FIG. 18E shows a new workflow template, “purchase flow,” being added to the list of workflow templates. FIG. 19 shows an example of the “Start Workflow” user interface being updated with the newly created workflow template, “purchase flow,” for starting a workflow, according to some embodiments disclosed herein.

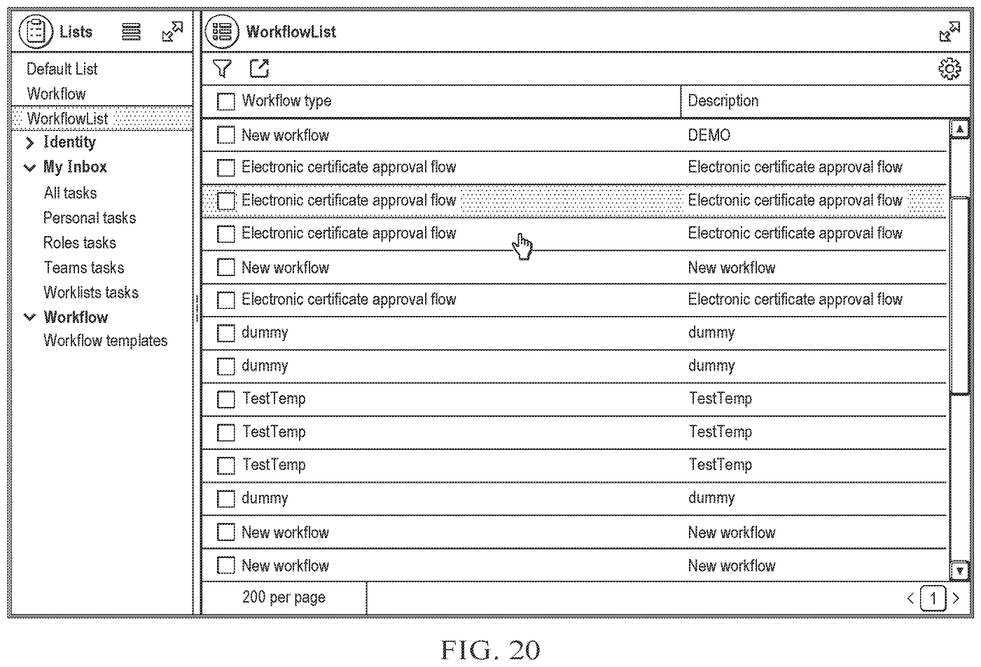

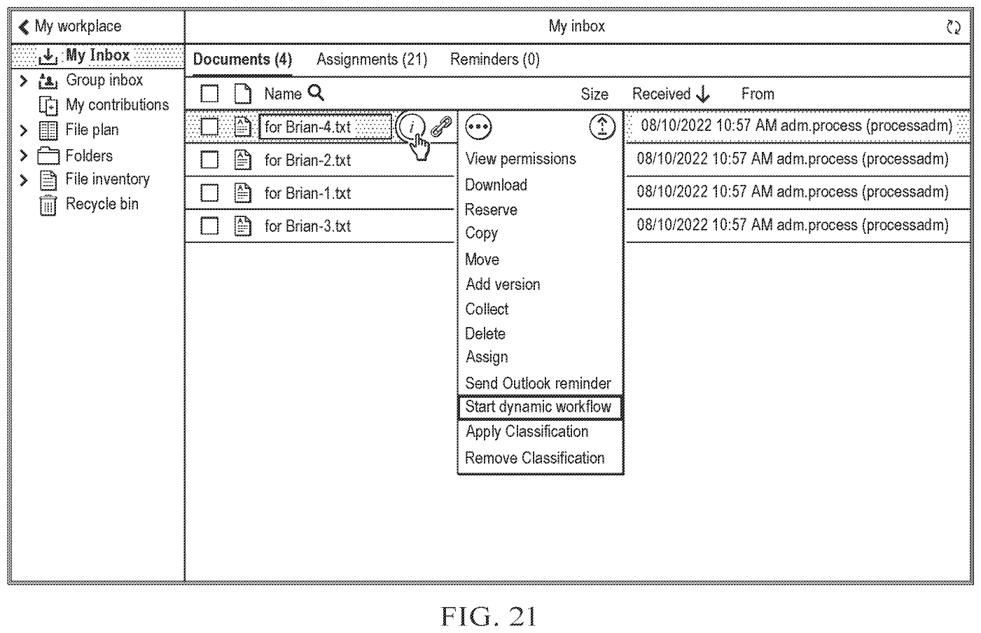

In embodiments disclosed herein, workflows can be started and then dynamically updated in various ways. In some embodiments, a workflow instance can be accessed from a list of workflows (FIG. 20). In some embodiments, a dynamic workflow can be started from a user's inbox/workspace (FIG. 21). On clicking on “Start dynamic workflow,” the “Start Workflow” page will load and the user can start a workflow from there. If so desired, the user can further configure the workflow before starting the workflow. With the dynamic workflow feature disclosed herein, the user can later dynamically configure the workflow after the workflow starts.

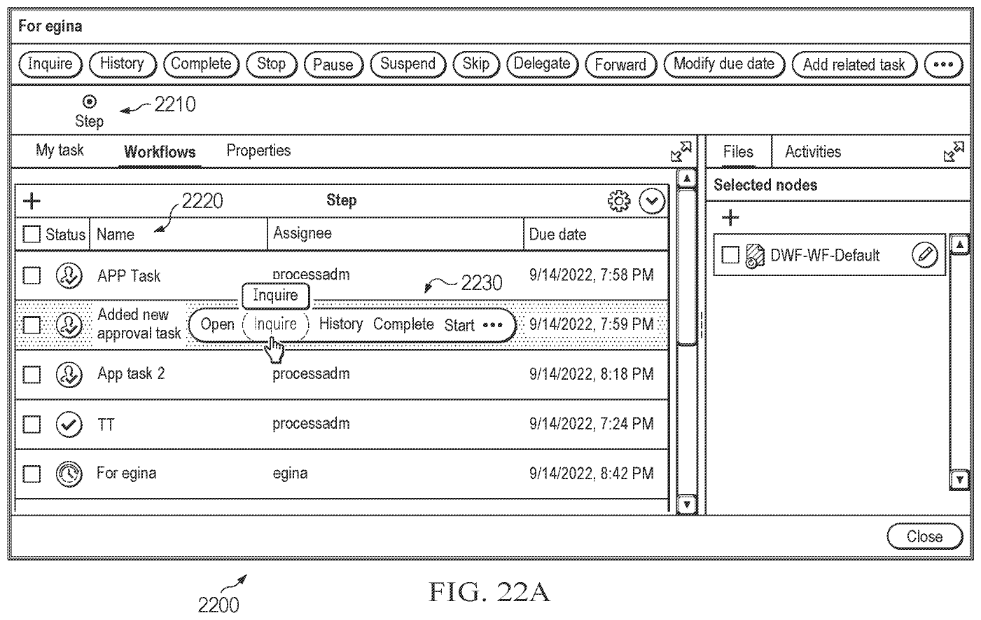

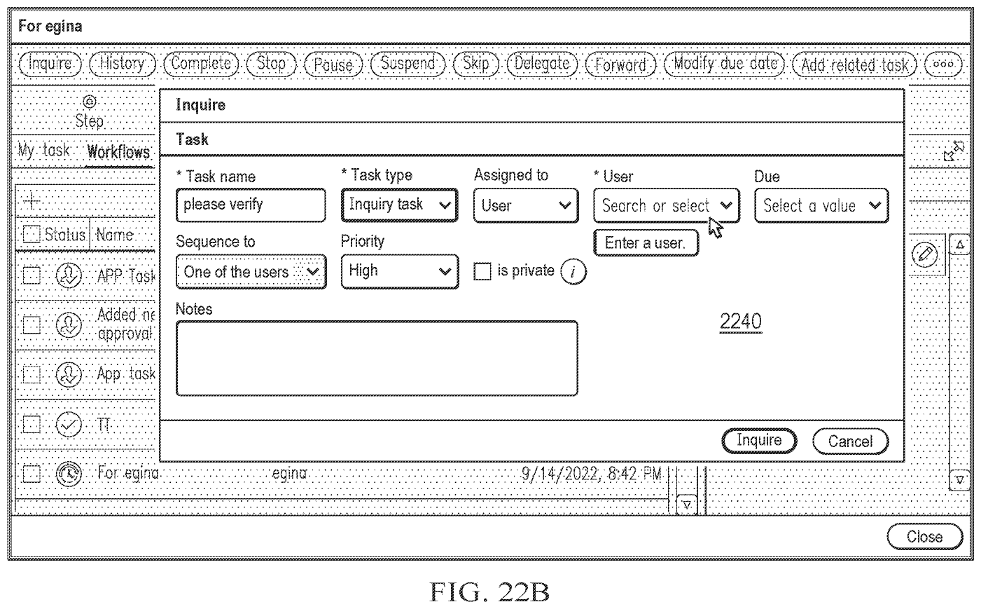

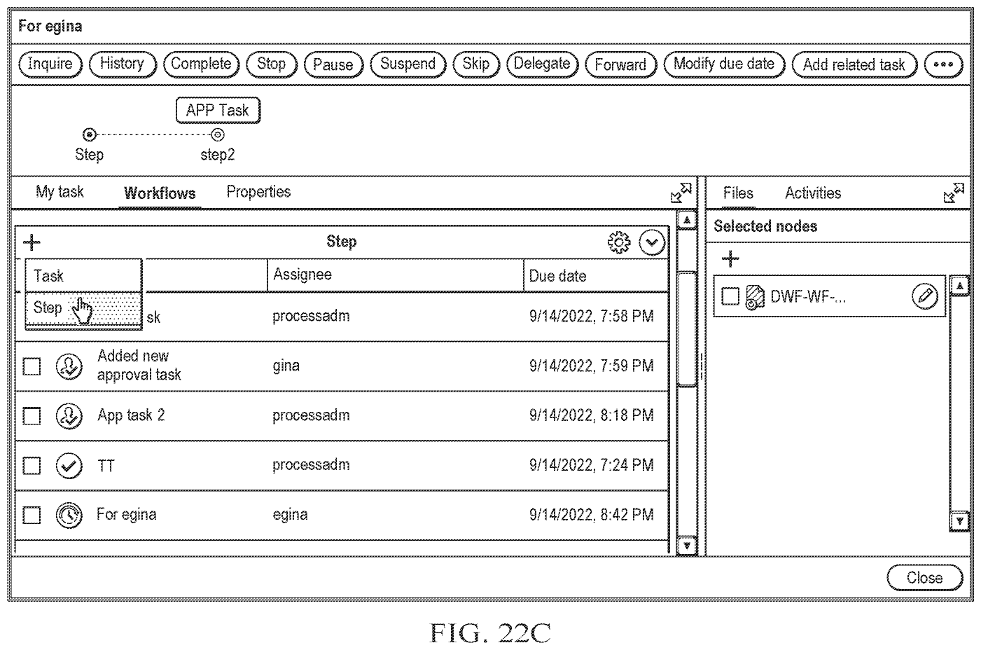

Once a workflow is started, FIGS. 22A-22C show by example how a user access the ongoing workflow according to some embodiments disclosed herein. As illustrated in FIG. 22A, which depicts a workflow summary view 2200 of a running workflow 2210, a user “egina” is permitted to view and access “work in progress” steps 2220 that have not yet been released. When the workflow summary view 2200 is displayed, details of the workflow are obtained from a workflow record (e.g., a workflow definition) in the database. As the user tries to add a step or a task, the workflow record is updated accordingly.

As an example, a user may access a menu 2230 to inquire about a step. As illustrated in FIG. 22B, in response to the user interaction with the menu 2230, an “inquire” UI 2240 is displayed with workflow step details (task fields). In this example, the task type does not have a due date because it is an inquiry task for information only. In some embodiments, only task types mapped with action ‘Autocomplete’ will have no due date and in user interface will have only ‘Acknowledge’ action. Inquiry is the default task type in a dynamic workflow. An inquiry task gets created when a user clicks on an Inquire action. In an inquiry task, the task type cannot be changed. The user can drill down further and inquire task details and/or navigate back to the workflow summary view shown in FIG. 22C.

At this time, the user can add a step, for instance, before or after the “App Task” step (step 2) of the workflow. The workflow definition is updated accordingly. As illustrated in FIG. 22C, the workflow progress panel is dynamically updated to reflect the progress of the workflow.

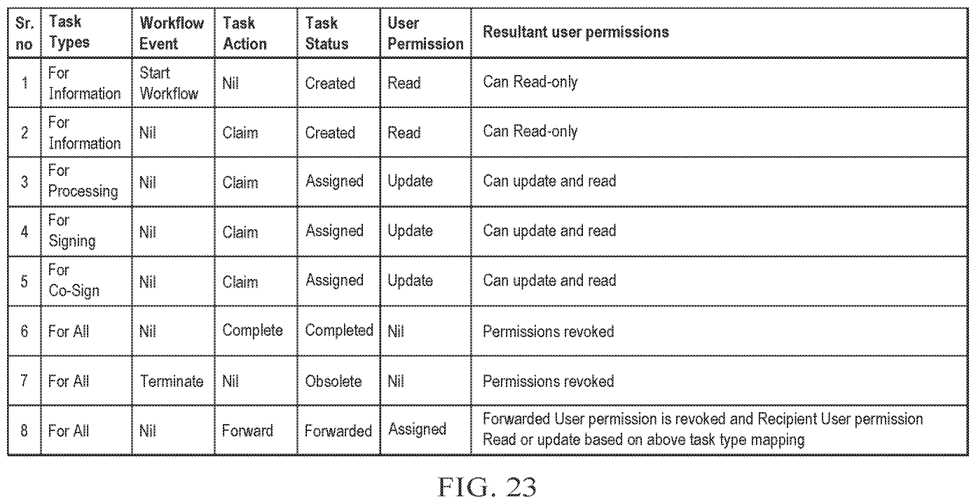

As illustrated by these examples, with a proper permission, an end user can select, modify, and/or add any step(s) and/or task(s). What the user is permitted to do with respect to an ongoing workflow can be configurable and may vary from implementation to implementation. FIG. 23 is a table with an example list of task types and associated user permissions, according to one embodiment disclosed herein. Based on workflow events and task actions, user permissions may be updated in real time.

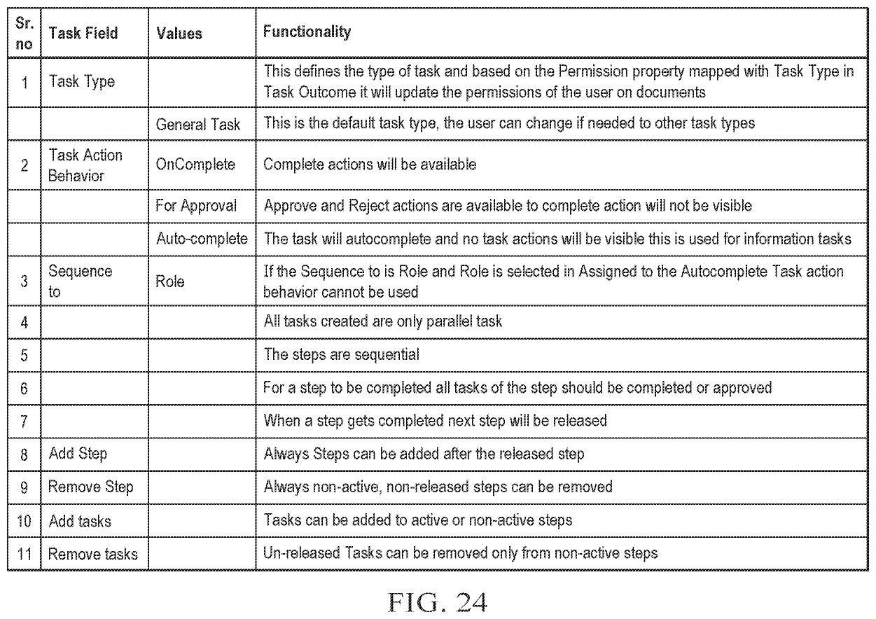

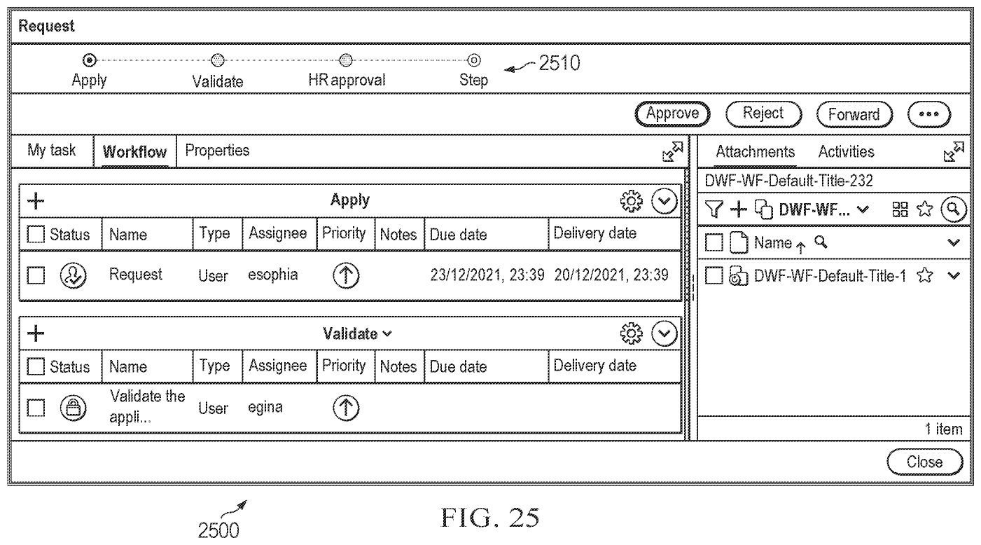

Those skilled in the art will appreciate that task fields may also vary from implementation to implementation. FIG. 24 is a table with an example list of task fields and associated functionality of tasks in a dynamic workflow, according to one embodiment disclosed herein. To start working on a task, an assignee of the task navigates to their inbox, selects assignments, and opens the task which was the first task in the first step. An example is illustrated in FIG. 25.

FIG. 25 depicts a diagrammatic representation of an example of a workflow summary view 2500 of a workflow 2510 at runtime, according to some embodiments disclosed herein. In this example, the workflow summary view 2500 shows the progress of the workflow, the user's task information, the workflow, and the workflow properties. The attachments tab shows any document(s) attached and the activities tab shows the audit logs. The action buttons are for the current task actions assigned to the logged-in user. Any user can add or remove task(s) or step(s) from the active workflow. To remove any task or step, the user can select the task or inactive step. In one embodiment, only the user who started a workflow can withdraw/terminate the workflow.

In the example of FIG. 25, the workflow progress panel shows that the workflow 2510 currently sits at the first of four steps. Previously, a step cannot be added to a workflow at runtime. The workflow summary view 2500 allows a user permitted to access the workflow 2510 to change a fairly linear process of the workflow 2510, virtually at any point beyond the current step. The user interaction with the workflow summary view 2500, and any changes made to the workflow 2510, is used to update a workflow definition associated with the workflow 2510. As discussed above, a workflow is instantiated as an instance of a workflow template. At any given time, there can be multiple (e.g., hundreds) instances of a workflow template. The dynamic workflow feature allows a user to edit any of these instances without affecting the workflow template, from which the workflow is instantiated.

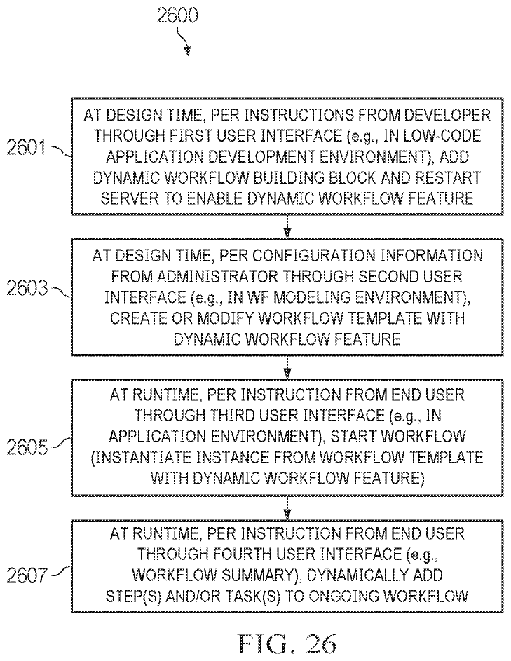

FIG. 26 depicts an example of an overall method 2600 for enabling a dynamic workflow feature for use in dynamically updating/configuring a workflow at runtime according to some embodiments. As a non-limiting example, at design time, a system implementing an embodiment of the invention disclosed herein may receive instructions to add a dynamic workflow building block from a developer through a first user interface in a low-code application development environment (2601).

As described above, building blocks are the bits and pieces of information that can be used to compose entities. Adding a building block to an entity can extend any of the following aspects of the entity, including at least one of a property, a permission, an action, a behavior, or a resource to the entity. These are further described below.

Properties-most building blocks can add properties to an entity. One example is the Property building block that adds a property. Another example is the Assignee building block which adds several properties: assignee, assigneeType, notifyAssignee, etc. This building block adds the concept of responsibility to an entity. In this case, an assignee is someone who is responsible for taking a required action.

Actions-many building blocks can add actions to an entity. Actions may be invoked programmatically or interactively. Typically, performing actions on an instance will affect in a change to the status of that instance.

Permissions—many building blocks can add permissions to an entity. These permissions can then be granted to roles to control access to the functionality provided by the Permission building block. For example, permissions may be used in Security Policies (which are also entity building blocks, see below), to control who can do what to instances of the entity. For example, the Versioning building block adds the permissions CheckOut and Manage Versions.

Behavior—many building blocks can alter the behavior of an entity. For example, the Retention building block can prevent an item from being deleted if it has not yet expired. A Behavior building block adds event-based logic that is triggered when a specific event takes place relative to an entity. Example events may include Access, Create, Delete, ChangeProperty, and so on.

APIs—some building blocks can extend the programmatic operations available on an entity. For example, the File building block adds a resource to the item resource normally used to manipulate items. As another example, adding REST resources can extend the programmatic interface of an entity.

Layout Panels—some building blocks can enable the use of additional layout panels in an entity's layouts. For example, if an entity object includes a child entity that includes the Project, Status, Assignee, Supporting Items and Deadline building blocks, the entity object's layout can include a Task Management panel. In some embodiments, layout panels related to the dynamic workflow building block can include Progress, Preview, Results, Tasks, Web Content, Start Workflow, Workflow Summary, etc. The “Start Workflow” layout panel is for selecting or configuring a workflow template and starting a workflow with user-specified workflow details. The “Workflow Summary” layout panel is for showing the workflow instance trigged by the start workflow. With the “Workflow Summary” layout panel, a user can view all the steps and tasks of the workflow instance and can update the active workflow by adding and/or removing task(s) and/or step(s).

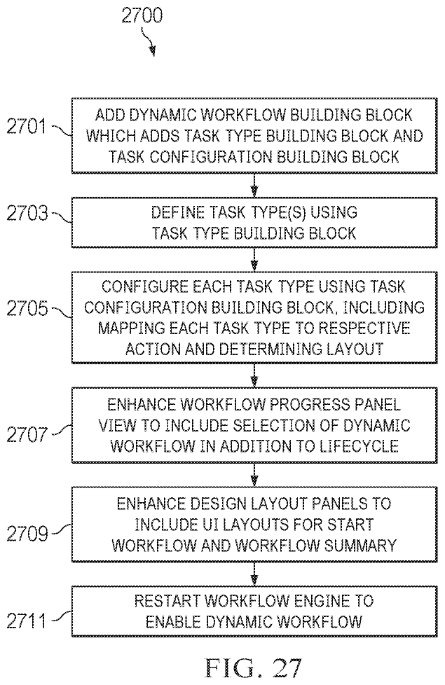

Referring to FIG. 27, which depicts an example of a method 2700 for enabling the dynamic workflow feature, adding a dynamic workflow building block to an entity adds a task type building block and a task configuration building block (2701). To use the dynamic workflow feature at runtime, an entity is required so that the dynamic workflow building block can be added to the entity in a workflow (or dynamic workflow) project at design time via, for instance, an entity model designer tool of the entity modeling system.

In some embodiments, the dynamic workflow building block is coded to include the task type building block and the task configuration building block. With the task type building block, a developer can define task types at design time (2703). With the task configuration building block, a developer can configure each task type. As discussed above, configuring a task type may include mapping the task type to an action and determining a layout (2705). Specifically, the workflow progress panel is enhanced to include a selection of a dynamic workflow progress panel (2707). Previously, the workflow progress panel only shows the progress of a lifecycle. Further, the design layout panels are enhanced to include a “Start Workflow” UI and a “Workflow Summary” UI (2709). A dynamic workflow has a separate progress bar which can be configured in a layout. This progress bar will work only for the dynamic workflow. Once these enhancements (e.g., to a workflow engine) are made at design time, the workflow engine is restarted to enable the dynamic workflow feature (2711).

Returning to FIG. 26, at design time (e.g., when modeling a workflow), an administrator can create or modify a workflow template through the “Start Workflow” UI, which is part of the dynamic workflow feature (2603). The administrator or an end user (e.g., a case owner) can start a workflow from the workflow template thus created or defined (2605). Starting a workflow, in this case, entails instantiating an instance of the workflow template. Once the instance is started, the administrator or an end user with the proper permission can edit/configure the instance on the fly by adding task(s) and/or step(s) through the “Work Summary” UI (2607).

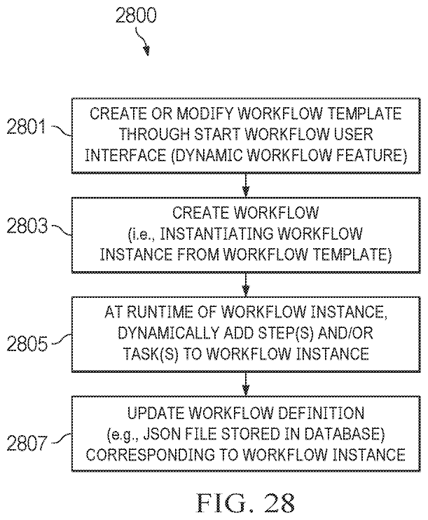

FIG. 28 depicts an example of a method 2800 that illustrates this dynamic workflow creation process in more detail. In this example, a dynamic workflow begins with the creation or modification of a workflow template (2801). The dynamic workflow template creation or modification is done from the workflow templates list and add workflow template action in the list. Created dynamic workflow templates will be picked in the Start Workflow to initiate a dynamic workflow. Next, in response to an instruction received through the “Start Workflow” UI to start a dynamic workflow, an instance of the workflow template is instantiated (2803). At runtime of the workflow instance, in response to an instruction received through the “Workflow Summary” UI, a step or a task can be dynamically injected or otherwise added to the dynamic workflow (2805). Multiple steps and/or multiple tasks can be added. The change(s) to the dynamic workflow can be captured by a case engine and used to update a workflow definition file associated with the particular workflow instance (2807).

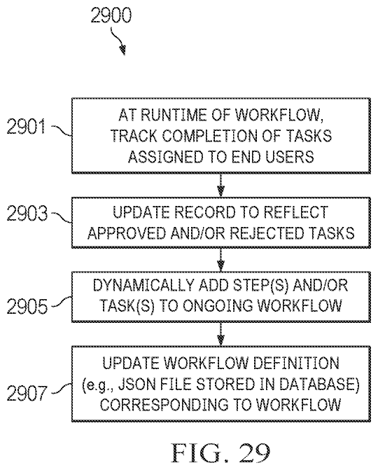

FIG. 29 depicts an example of a method 2900 that illustrates this dynamic workflow configuration in more detail. In this example, the workflow engine is operable to track the status of each task (2901). When a task is complete, the workflow engine is operable to update an entry in a database (i.e., a record for the instance) to reflect a result of the task (e.g., approved or rejected) (2903). At this time, a user may wish to dynamically add a step(s) and/or a task(s) to the workflow. Per the user input, which is received through the “Workflow Summary” UI, the workflow engine is operable to add the step(s) and/or task(s) (2905) and update a workflow definition file (e.g., a JSON file) corresponding to the workflow instance accordingly (2907).

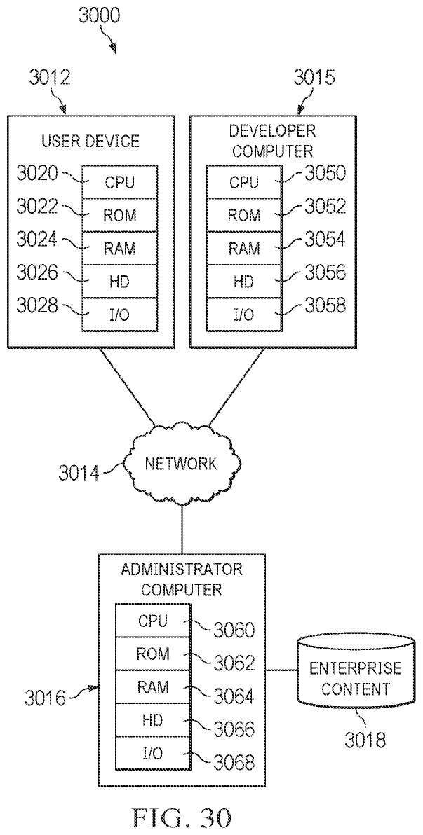

FIG. 30 depicts a diagrammatic representation of an example of a network environment where embodiments disclosed can be implemented. In the example illustrated, network environment 3000 includes network 3014 that can be bi-directionally coupled to user device 3012, developer computer 3015, and administrator computer 3016. Administrator computer 3016 can be bi-directionally coupled to data store 3018. Network 3014 may represent a combination of wired and wireless networks that network computing environment 3000 may utilize for various types of network communications known to those skilled in the art.

For the purpose of illustration, a single system is shown for each user device 3012, developer computer 3015, and administrator computer 3016. However, within each of user device 3012, developer computer 3015, and administrator computer 3016, a plurality of networked devices and computers alike (not shown) may be interconnected to each other over network 3014. For example, a plurality of user devices 3012, a plurality of administrator computers 3016, and a plurality of developer computers 3015 may be coupled to network 3014.

User device 3012 can include central processing unit (“CPU”) 3020, read-only memory (“ROM”) 3022, random access memory (“RAM”) 3024, hard drive (“HD”) or storage memory 3026, and input/output device(s) (“I/O”) 3028. I/O 3028 can include a keyboard, monitor, printer, electronic pointing device (e.g., mouse, trackball, stylus, etc.), or the like. User device 3012 can include a desktop computer, a laptop computer, a personal digital assistant, a cellular phone, or nearly any network-enabled device capable of communicating over a network. Developer computer 3015 may be similar to user computer 3012 and can comprise CPU 3050, ROM 3052, RAM 3054, HD 3056, and I/O 3058.

Likewise, administrator computer 3016 may include CPU 3060, ROM 3062, RAM 3064, HD 3066, and I/O 3068. Data store 3018 may comprise a data storage device storing data, programming logic, and processing logic, etc. Many other alternative configurations are possible and known to skilled artisans.

Each of the computers in FIG. 30 may have more than one CPU, ROM, RAM, HD, I/O, or other hardware components. For the sake of brevity, each computer is illustrated as having one of each of the hardware components, even if more than one is used. Each of computers 3012, 3015, and 3016 is an example of a data processing system. ROM 3022, 3052, and 3062; RAM 3024, 3054, and 3064; HD 3026, 3056, and 3066; and data store 3018 can include media that can be read by CPU 3020, 3050, or 3060. Therefore, these types of memories include non-transitory computer-readable storage media. These memories may be internal or external to computers 3012, 3015, or 3016.

Portions of the methods described herein may be implemented in suitable software code that may reside within ROM 3022, 3052, or 3062; RAM 3024, 3054, or 3064; or HD 3026, 3056, or 3066. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the invention should be determined by the following claims and their legal equivalents.

What is claimed is:

1. A method, comprising:
at design time, enabling a dynamic workflow feature, the enabling comprising adding a dynamic workflow building block to an entity in a modeling project in an entity-based application, the dynamic workflow building block comprising a task type building block and a task configuration building block;
at design time, defining a task type using the task type building block;
at design time, mapping the task type to a task action using the task configuration building block;
at design time, creating a dynamic workflow progress panel;
at design time, creating layout panels including a first layout panel for starting a workflow and a second layout panel for summarizing the workflow once started;
at runtime of the entity-based application, creating or modifying a workflow template responsive to user interaction with the first layout panel;
at runtime of the entity-based application, instantiating an instance of the workflow template responsive to user interaction with the first layout panel; and
at runtime of the instance, dynamically adding a task or a step to the instance responsive to user interaction with the second layout panel.

2. The method according to claim 1, further comprising:
responsive to the dynamically adding, updating a workflow definition file for the instance and storing the workflow definition file thus updated in a database.

3. The method according to claim 1, wherein the creating or modifying a workflow template is performed responsive to user interaction with the first layout panel, the method further comprising:
saving an instance of the workflow template thus created or modified as a new workflow template.

4. The method according to claim 1, wherein the second layout panel comprises the dynamic workflow progress panel and wherein the dynamic workflow progress panel shows the instance as the instance progresses from step to step.

5. The method according to claim 1, wherein both the first layout panel and the second layout panel comprise a step menu, wherein the step menu of the first layout panel is for adding a step to a workflow or workflow template at design time and wherein the step menu of the second layout panel is for dynamically adding a step to the instance at runtime of the instance.

6. The method according to claim 1, wherein both the first layout panel and the second layout panel comprise a task menu, wherein the task menu of the first layout panel is for adding a task to a step of a workflow or workflow template at design time and wherein the task menu of the second layout panel is for dynamically adding a task to a step of the instance at runtime of the instance.

7. The method according to claim 1, further comprising:
responsive to user interaction with the task configuration building block, creating or specifying a layout for the task type.

8. A system, comprising:
a processor;
a non-transitory computer-readable medium; and
instructions stored on the non-transitory computer-readable medium and translatable by the processor for:
at design time, enabling a dynamic workflow feature, the enabling comprising adding a dynamic workflow building block to an entity in a modeling project in an entity-based application, the dynamic workflow building block comprising a task type building block and a task configuration building block;
at design time, defining a task type using the task type building block;
at design time, mapping the task type to a task action using the task configuration building block;
at design time, creating a dynamic workflow progress panel;
at design time, creating layout panels including a first layout panel for starting a workflow and a second layout panel for summarizing the workflow once started;
at runtime of the entity-based application, creating or modifying a workflow template responsive to user interaction with the first layout panel;
at runtime of the entity-based application, instantiating an instance of the workflow template responsive to user interaction with the first layout panel; and
at runtime of the instance, dynamically adding a task or a step to the instance responsive to user interaction with the second layout panel.

9. The system of claim 8, wherein the instructions are further translatable by the processor for:
responsive to the dynamically adding, updating a workflow definition file for the instance and storing the workflow definition file thus updated in a database.

10. The system of claim 8, wherein the creating or modifying a workflow template is performed responsive to user interaction with the first layout panel and wherein the instructions are further translatable by the processor for:
saving an instance of the workflow template thus created or modified as a new workflow template.

11. The system of claim 8, wherein the second layout panel comprises the dynamic workflow progress panel and wherein the dynamic workflow progress panel shows the instance as the instance progresses from step to step.

12. The system of claim 8, wherein both the first layout panel and the second layout panel comprise a step menu, wherein the step menu of the first layout panel is for adding a step to a workflow or workflow template at design time and wherein the step menu of the second layout panel is for dynamically adding a step to the instance at runtime of the instance.

13. The system of claim 8, wherein both the first layout panel and the second layout panel comprise a task menu, wherein the task menu of the first layout panel is for adding a task to a step of a workflow or workflow template at design time and wherein the task menu of the second layout panel is for dynamically adding a task to a step of the instance at runtime of the instance.

14. The system of claim 8, wherein the instructions are further translatable by the processor for:
responsive to user interaction with the task configuration building block, creating or specifying a layout for the task type.

15. A computer program product comprising a non-transitory computer-readable medium storing instructions translatable by a processor for:
at design time, enabling a dynamic workflow feature, the enabling comprising adding a dynamic workflow building block to an entity in a modeling project in an entity-based application, the dynamic workflow building block comprising a task type building block and a task configuration building block;
at design time, defining a task type using the task type building block;
at design time, mapping the task type to a task action using the task configuration building block;
at design time, creating a dynamic workflow progress panel;
at design time, creating layout panels including a first layout panel for starting a workflow and a second layout panel for summarizing the workflow once started;
at runtime of the entity-based application, creating or modifying a workflow template responsive to user interaction with the first layout panel;
at runtime of the entity-based application, instantiating an instance of the workflow template responsive to user interaction with the first layout panel; and
at runtime of the instance, dynamically adding a task or a step to the instance responsive to user interaction with the second layout panel.

16. The computer program product of claim 15, wherein the instructions are further translatable by the processor for:
responsive to the dynamically adding, updating a workflow definition file for the instance and storing the workflow definition file thus updated in a database.

17. The computer program product of claim 15, wherein the creating or modifying a workflow template is performed responsive to user interaction with the first layout panel and wherein the instructions are further translatable by the processor for:
saving an instance of the workflow template thus created or modified as a new workflow template.

18. The computer program product of claim 15, wherein the second layout panel comprises the dynamic workflow progress panel and wherein the dynamic workflow progress panel shows the instance as the instance progresses from step to step.

19. The computer program product of claim 15, wherein both the first layout panel and the second layout panel comprise a step menu and a task menu, wherein the step menu of the first layout panel is for adding a step to a workflow or workflow template at design time, wherein the step menu of the second layout panel is for dynamically adding a step to the instance at runtime of the instance, wherein the task menu of the first layout panel is for adding a task to a step of a workflow or workflow template at design time, and wherein the task menu of the second layout panel is for dynamically adding a task to a step of the instance at runtime of the instance.

20. The computer program product of claim 15, wherein the instructions are further translatable by the processor for:
responsive to user interaction with the task configuration building block, creating or specifying a layout for the task type.
